(19) United States
(12) Patent Application Publication
(10) Pub. No.: US 2026/0352500 A1
(43) Pub. Date: Nov. 5, 2026

(54) COMPUTER-IMPLEMENTED METHODS AND SYSTEMS FOR OBTAINING OR USING SVD-BASED ASSETS ON A BLOCKCHAIN

(71) Applicant: nChain Licensing AG, Zug (CH)

(72) Inventors: Craig Steven WRIGHT, London (GB); Jack Owen DAVIES, London (GB)

(21) Appl. No.: 19/163,297

(22) PCT Filed: Mar. 12, 2024
(86) PCT No.: PCT/EP2024/056507

§ 371 Date: Sep. 8, 2025

(30) Foreign Application Priority Data
Mar. 13, 2023 (GB) 2303629.6
Mar. 13, 2023 (GB) 2303632.0
Mar. 13, 2023 (GB) 2303643.7
Mar. 13, 2023 (GB) 2303644.5

(51) Int. Cl. H04L 9/00

(52) U.S. Cl. CPC H04L 9/50

(57) ABSTRACT

Embodiments utilise Singular Value Decomposition (SVD) to provide improved techniques for generating, processing, controlling, transferring and/or implementing blockchain-based tokens and other assets. Such tokens may include, but are not limited to, non-fungible tokens (NFTs). In one possible embodiment, an SVD-based digital asset is created by applying SVD to one or more existing digital asset(s) e.g. image(s). In an alternative approach, the SVD-based digital asset can be created from an artificially constructed SVD rather than based on any existing digital asset(s). Embodiments are also provided for secure, encrypted transmission of digital assets and tokens between parties, and for improved storage and processing of such assets and tokens, in particular when storing/processing on a blockchain ledger.

### CROSS REFERENCE TO RELATED APPLICATIONS

This application is the U.S. National Stage of International Application No. PCT/EP2024/056507 filed on Mar. 12, 2024, which claims the benefit of United Kingdom Patent Application No. 2303629.6 filed on Mar. 13, 2023, United Kingdom Patent Application No. 2303632.0 filed on Mar. 13, 2023, United Kingdom Patent Application No. 2303643.7 filed on Mar. 13, 2023, United Kingdom Patent Application No. 2303644.5 filed on Mar. 13, 2023, the contents of which are all incorporated herein by reference in their entireties.

### TECHNICAL FIELD

The present disclosure relates to improved techniques and systems for processing digital or digitised assets, in particular tokenised assets that are stored, transferred, accessed or otherwise processed via a blockchain. Some embodiments provide novel techniques for generating assets for subsequent tokenisation, while others provide novel techniques for using, controlling, transferring, verifying and/or securing blockchain-based tokens and/or their associated assets.

Benefits provided by embodiments disclosed herein include, but are not limited to, improved security and control of tokenised assets, improved authentication and verification of ownership, improved data permanence and digital preservation, Digital Rights Management (DRM) solutions, improved secret splitting and threshold schemes for ensuring the privacy and security of data being transferred between parties, and improved efficiency of data storage on blockchain ledgers.

### BACKGROUND

It is readily understood that the inherent properties of blockchain technologies give rise to advantages that extend far beyond simply providing a vehicle for the transfer of currency related assets. Over recent years, attention has turned to the use of the blockchain as a platform upon which a variety of technical applications can be implemented. Blockchain-based solutions have been devised for storing, securing, sharing, transferring and authenticating diverse types of data. Tokenisation schemes provide one such approach and involve some physical, virtual or digital asset being represented via a token that is stored in the ledger.

However, while tokenisation brings its benefits, it also poses challenges. These include, but are not limited to, how to store and process asset-related data on-chain in an efficient way, how to prevent plagiarism, theft or fraud of tokenised assets, how to ensure data preservation if an on-chain token becomes disassociated from the off-chain asset that it represents, and how to verify the legitimacy of the tokenised asset as well as its ownership.

Embodiments of the disclosure provide technical arrangements which solve or alleviate at least these challenges.

### SUMMARY

Embodiments of the present disclosure comprise methods, systems and apparatus for the generation, transfer, use, storage or otherwise processing of at least one SVD-based asset. This may be referred to as a SVD-based blockchain asset.

An embodiment may comprise the use of the singular value decomposition (SVD) to generate one or more SVD-based digital assets. The SVD-based digital asset(s) may be used to obtain the at least one SVD-based blockchain asset. A SVD-based blockchain asset may be an SVD-based digital asset that is stored in or in association with, or referenced from, a blockchain ledger or in a transaction that is formed in accordance with a blockchain protocol. Additionally, or alternatively, it may comprise or be associated with logic code relating to the generation or use of a blockchain-based asset/token e.g. a smart contract.

The SVD-based digital asset(s) may be used, or arranged for use, by any suitable blockchain-related protocol, scheme or method. In some cases, the blockchain-related protocol/method may be a tokenisation protocol (which may also be referred to as a ‘tokenisation scheme’). It may be a method/protocol for the generation of non-fungible tokens (NFTs). The blockchain-related protocol/method/scheme may be an application-layer protocol/method in that it is distinct from a blockchain protocol/method that is executed by nodes on a blockchain network to implement a blockchain and its associated network.

The blockchain protocol/method scheme may generate a (blockchain) asset e.g. token that represents the SVD-based digital asset. The token may be stored in a block on a blockchain ledger of a blockchain. It may be stored in a transaction in a block on the blockchain ledger. The blockchain ledger may simply be referred to as ‘a blockchain’ for ease of reference.

One, some or all of the SVD-based digital asset(s) may be stored on the blockchain ledger. Additionally, or alternatively, one some or all of the SVD-based digital asset(s) may be stored off the blockchain ledger (i.e. ‘off-chain’) in one or more storage resources.

Preferred embodiments of the present disclosure may provide technical solutions that comprise at least one or more of:
Using the SVD to generate at least one SVD-based digital asset;
generating at least one SVD-based digital asset by using the SVD to process at least one original (i.e. existing) digital asset and produce at least one SVD-based digital asset;
generating at least one SVD-based digital asset that is derived from at least one artificially constructed SVD;
encrypting at least one part of a SVD-based digital asset.

The disclosure may also provide solutions that obtain or provide SVD-based blockchain asset(s) that are derived from or associated with one or more SVD-based digital assets.

Moreover, one some or all embodiments may exploit the hierarchical property of the SVD to benefit blockchain-based solutions in at least the following ways:
To minimise the on-chain storage requirements of blockchain-based tokenisation solutions;
To allow the creation of multiple, possibly many, versions of a base asset;
To enable the creation and control of an asset at different levels of fidelity/quality;
To allow the content and/or attribute(s) of an asset to be updated over time (e.g. to reflect a change in ownership or some other criteria such as number of accesses of the asset, or lapsing of a predetermined period of time etc.);
To allow pluralities (collections) of assets to be generated from a single base asset; and
To allow new assets to be generated from an existing asset collection.

SVD is known in the art for numerous applications. For example, it forms the basis of dimensionality reduction for machine learning in principal components analysis, and is used in technical fields such as signal processing, image processing and facial recognition. However, embodiments of the disclosure apply the SVD to advantage in novel ways in order to provide improved processing of blockchain-based assets. Such embodiments may modify, generate and process (digital) assets that are to be stored or represented on a blockchain.

In accordance with one aspect of the disclosure, embodiments use the SVD to allow splitting, transfer, and ownership of individual, distinct components of an asset.

In accordance with another aspect, embodiments utilise the hierarchical property of the SVD to create a new form of generative (digital) asset.

In yet another aspect, embodiments provide tokenised assets that enable new functionalities for existing tokenisation solutions, such as the ability to update or watermark the contents of a (digital) asset.

According to one or more embodiments disclosed herein, methods and systems are provided in which the SVD is used to extract one or more features from at least one existing digital asset e.g. a digital image. One or more modifications may then be made to the extracted feature(s) to generate a new version of the original feature. The change(s) may be small or simple, but result in a modification of some type. The SVD can then be multiplied back out to provide a modified, SVD-based digital asset.

Advantageously, this enables a derivative of the original digital asset to be created which comprises an embedded modification. This modification may be performed in a variety or way, for a variety of purposes, as explained below. From one perspective, this may be described as ‘watermarking’ the original so that a verifiable marker is embedded within it, enabling its history, authenticity or ownership to be attested.

In other embodiments, SVD can be used to provide enhanced security techniques for transferring digital assets between parties. In some cases, the digital assets may be or comprise blockchain-based tokens, but not necessarily so. In other cases, the digital assets may be used for the generation of blockchain-based tokens but, again, the disclosure is not limited in this regard and the SVD-base encryption techniques described herein can be used with respect to any kind of digital asset when it needs to be stored, accessed or transmitted in a controlled and secure manner.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain.

FIG. 2 schematically illustrates some examples of transactions which may be recorded in a blockchain.

FIG. 3A is a schematic block diagram of a client application.

FIG. 3B is a schematic mock-up of an example user interface that may be presented by the client application of FIG. 3A.

FIG. 4 is a schematic block diagram of some node software for processing transactions.

FIG. 5 shows an example of matrix addition for the purpose of illustration.

FIG. 6a shows an example of matrix multiplication, in which the calculation of term c₂₂ is highlighted.

FIG. 6b shows the matrix multiplication of FIG. 6a in the reverse order.

FIG. 7 shows the Singular Value Decomposition (SVD) of a matrix A into the product of three matrices U, Σ, V^{T}, for the purpose of illustration.

FIG. 8 provides a visualisation of the rank-r approximation of a matrix A.

FIG. 9 shows the relationship between the economy SVD and matrix approximation by truncation.

FIG. 10 provides the SVD expansion of an image to illustrate how an image can be approximated by keeping the first r terms in the expansion.

FIG. 11 provides three examples of a new NFT A′ generated in accordance with an illustrative embodiment by randomly modifying the singular values in the SVD of an original image A.

FIG. 12 provides an illustration in accordance with an embodiment that enables separation of the individual components of a digital entity, and in which the series sum expansion of an SVD-based digital entity is separated into separately controlled, stored or processed components.

FIG. 13 provides a high-level overview of embodiments of the disclosure, in which different techniques can be used to generate an SVD-based digital asset that is subsequently used in a blockchain-based tokenisation scheme such as, but not limited to, a non-fungible token (NFT) scheme.

### DETAILED DESCRIPTION—TECHNICAL BACKGROUND

We now provide, without limitation of the embodiments disclosed herein, some background for elucidation of the technical context.

### Matrices

A matrix is a two-dimensional rectangular array of elements arranged in rows and columns. An m×n matrix is a matrix with m rows and n columns. We denote a matrix A using a capital letter, and its elements aᵢⱼ, where i and j denote that the element is in the i^{th} column and j^{th} row of the matrix. In general, an m×n matrix A can be written as follows:

$$A = [ \begin{matrix}{a}_{11} & {a}_{12} & … & {a}_{1 n} \\ {a}_{21} & {a}_{22} & … & {a}_{2 n} \\ ⋮ & ⋮ & ⋱ & ⋮ \\ {a}_{m 1} & {a}_{m 2} & … & {a}_{m n}\end{matrix} ]$$

Matrices are used to represent linear transformations, or linear maps, which can map one vector u∈U in one vector space onto another vector v∈V in another vector space. The action of a matrix on such a vector can be written as Au=v.

Generally, an m×n matrix will map an n-dimensional vector onto an m-dimensional vector. This can be written as the following matrix equation, also known as a right linear map.

$$Au = [ \begin{matrix}{a}_{11} & {a}_{12} & … & {a}_{1 n} \\ {a}_{21} & {a}_{22} & … & {a}_{2 n} \\ ⋮ & ⋮ & ⋱ & ⋮ \\ {a}_{m 1} & {a}_{m 2} & … & {a}_{m n}\end{matrix} ] [ \begin{matrix}{u}_{1} \\ {u}_{2} \\ ⋮ \\ {u}_{n}\end{matrix} ] = [ \begin{matrix}{v}_{1} \\ {v}_{2} \\ ⋮ \\ {v}_{m}\end{matrix} ] = v$$

### Matrix Addition:

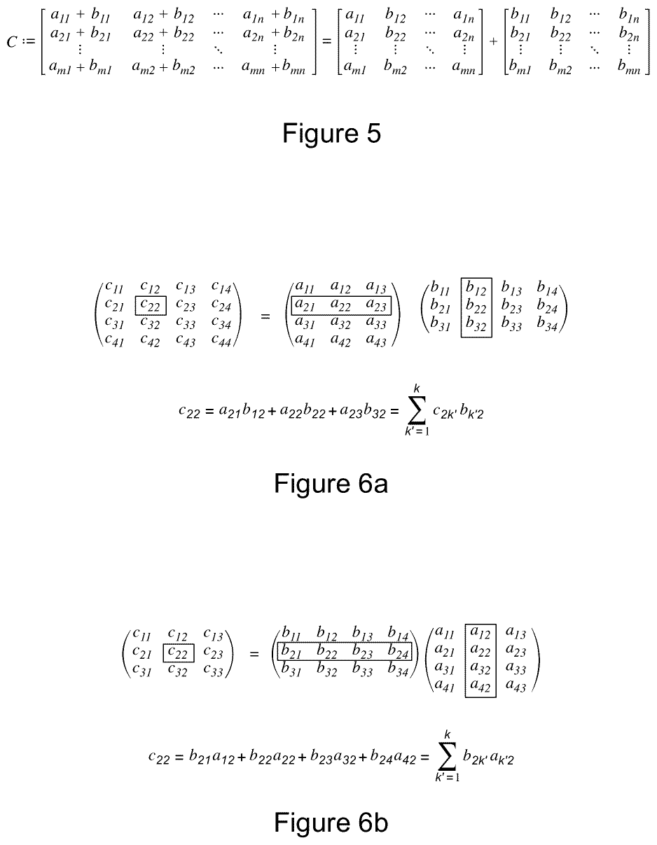

We can add two matrices A, B, given they have the same dimensions, by computing the element-wise sum cᵢⱼ=aᵢⱼ+bᵢⱼ of each entry in the resulting matrix C=A+B. This can be written as shown in FIG. 5, which shows an example of matrix addition for the purpose of illustration.

### Matrix Multiplication:

Two matrices can be multiplied if they share a common dimension. Given an m×k matrix A and a k×n matrix B, the m×n matrix product C=AB can be found. The entries of C are defined as:

$${c}_{i j} = {\sum }_{{k}^{′} = 1}^{k} {a}_{{ik}^{′}} {b}_{{k}^{′} j}$$

As an example, consider a 4×3 matrix A and a 3×4 matrix B. We can multiply these matrices to generate the 4×4 matrix product C=AB because both A and B have a dimension equal to 3. The resulting matrix C and its elements are shown in FIG. 5, in which the calculation of term c₂₂ is highlighted.

Note that, since A and B share a second dimension, in this case equal to 4, we could also multiply them in the opposite order to generate a 3×3 product matrix C′. This is illustrated in FIG. 6, which shows the matrix multiplication of FIG. 5 in reverse order.

As we find in this example, C≠C′, the matrix product is non-commutative. In other words, the order of operations is important in matrix multiplication since AB #BA in general.

### Eigenvalues and Eigenvectors:

The linear transformation represented by a given matrix A: u∈U→v∈V will generally be a combination of rotation and scaling of the input vector u. A rotation will change the direction of u, while a scaling will change the magnitude of u, which together produce the new vector v.

However, for a given transformation A there may also exist special vectors, known as eigenvectors, which are not rotated by A. These vectors are simply scaled by factors A, which are known as eigenvalues. The eigenvectors and corresponding eigenvalues for a given transformation matrix A are solutions to the characteristic equation, written as follows:

Av=λv

Since the vector v is the same on either side of the characteristic equation the matrix A must be a square (m×m) matrix. In other words, we can only find eigenvectors and eigenvalues for square matrices. Also note that, if A=0 is an eigenvalue of A, then A is a non-invertible matrix.

### Singular Value Decomposition (SVD):

The eigenvectors of a linear transformation can be used to understand and study the nature of the transformation by a process known as decomposition. However, many matrices we wish to study are rectangular (m≠n) in practice. Since eigenvalues and eigenvectors can only be found for square matrices, we cannot use standard decomposition methods to study such transformations.

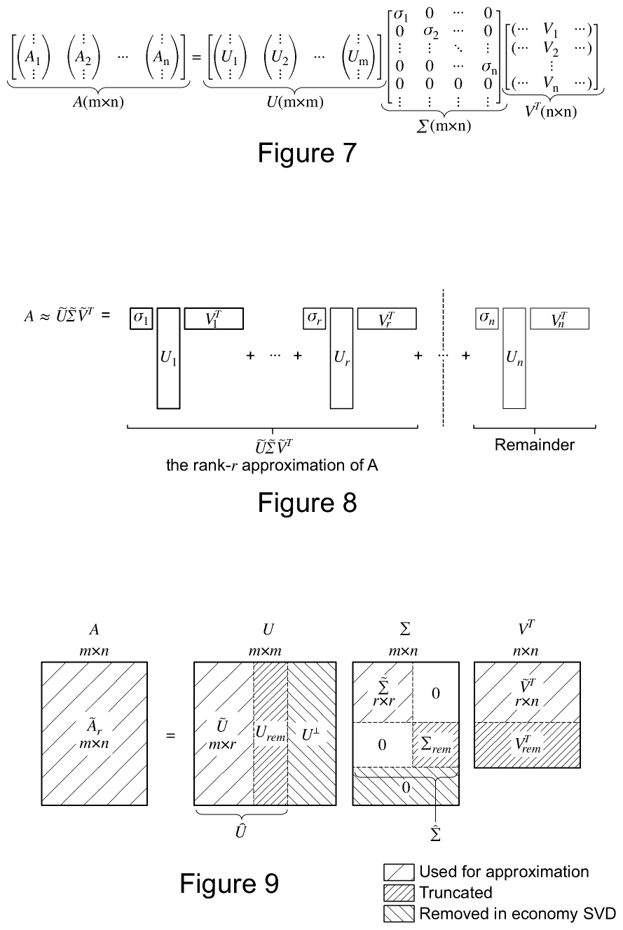

The singular value decomposition (SVD) is the analogue of an eigenvalue decomposition for rectangular matrices. The SVD of a matrix A can also be understood as its factorisation into the product of three new matrices U, Σ, V^{T}, written as SVD(A)=UΣV^{T}=A. To illustrate this, we provide FIG. 7 which shows the SVD of a matrix A into the product of three matrices U, Σ, V^{T}.

As shown in expanded form in FIG. 7, the SVD of an m×n matrix A is its decomposition into an m×m matrix U, an m×n matrix Σ, and an n×n matrix V^{T}. The above assumes that A has exactly n singular values but, in general, it will have r≤min (m,n) singular values, where r is the rank of matrix A. We now define each of these four matrices and explain their interpretation.

### Data Matrix (A):

The SVD is commonly used in data science to decompose a matrix A, comprising real data, which we call the data matrix. Typically, this data matrix will represent a dataset with a high dimensionality such that m>>n.

For instance, in facial recognition applications, A may encode a set of images of faces, whereby each column of A is an ordered list of the pixels that make up an image. If each image consists of one million pixels, and the dataset only includes one thousand faces, then the shape of A is 10⁹×10³ and we have m>>n. Recognising that each column of A represents a high-dimension entry in our dataset, we can write A as a matrix of n column vectors A₁, . . . , Aₙ as follows.

$$A = [ \begin{matrix}{a}_{11} & {a}_{12} & … & {a}_{1 n} \\ {a}_{21} & {a}_{22} & … & {a}_{2 n} \\ ⋮ & ⋮ & ⋱ & ⋮ \\ {a}_{m 1} & {a}_{m 2} & … & {a}_{m n}\end{matrix} ] = [ \begin{matrix}( \begin{matrix}⋮ \\ {A}_{1} \\ ⋮\end{matrix} ) & ( \begin{matrix}⋮ \\ {A}_{2} \\ ⋮\end{matrix} ) & … & ( \begin{matrix}⋮ \\ {A}_{n} \\ ⋮\end{matrix} ) ]\end{matrix} ,$$

$${A}_{1} = ( \begin{matrix}{a}_{11} \\ {a}_{21} \\ ⋮ \\ {a}_{m 1}\end{matrix} ) , {A}_{2} = ( \begin{matrix}{a}_{12} \\ {a}_{22} \\ ⋮ \\ {a}_{m 2}\end{matrix} ) , … , {A}_{n} = ( \begin{matrix}{a}_{1 n} \\ {a}_{2 n} \\ ⋮ \\ {a}_{m n}\end{matrix} )$$

The goal of the SVD is to express this data matrix as a product of matrices, which reveal the key features of the data contained in A and can be used to approximate A with minimal information loss.

### Singular Vectors and Singular Values:

Before defining the product matrices U, Σ, V^{T}, we must first define what is meant by the singular vectors and singular values of a matrix. The singular vectors of a rectangular matrix are analogous to the eigenvectors of a square matrix. In fact, the singular vectors of a rectangular matrix A are defined as the eigenvectors of the correlation matrix of A.

The correlation matrix of A is a square matrix that can be written in one of two ways: either as AA^{T} or as A^{T}A. Recall that, since A is an m×n matrix, the dimensions of AA^{T} will be m×m and the dimensions of A^{T}A will be n×n. Based on these correlation matrices, we can define the set of left singular vectors {u} and the set of right singular vectors {v} of the matrix A as the vectors that solve the respective eigenvector equations:

AA^{T}u=λu

A^{T}Av=λv

Note the dimensions of the left singular vectors are m×1 while the right singular vectors are n×1. We interpret the left singular vectors of A as the basis for the column space of A, which are sometimes referred to as the “eigenfaces” of A in reference to data matrices where each column of A is the image of a face. In other words, the columns of A can be expressed as linear combinations of left singular vectors {u}. Similarly, we interpret the right singular vectors of A as the basis for the row space of A.

The set of singular values {σ} of A are defined simply as σᵢ=√λᵢ, where λᵢ is the i^{th} positive eigenvalue of the above eigenvector equations. The magnitude of these singular values corresponds to the relative ‘importance’ of the corresponding singular vectors. In other words, if σ₁ is the largest singular value of A, then the corresponding singular vectors u₁, v₁, which solve AA^{T}u₁=λuᵢ and A^{T}AV₁=λvₗ respectively, have the greatest impact in describing the dataset within A.

### Singular Vector Matrices (U,V^{T}):

The SVD decomposes the data matrix into the product A=UΣV^{T}. The matrices on the left and right of this product, namely U and V^{T}, encode the singular vectors of A. On the left of the SVD product sits the m×m matrix U of left singular vectors.

We herein denote the columns of U by Uᵢ∀i∈[1,m]. These columns are identical to the left singular vectors of A, as shown below.

$$U = [ \begin{matrix}{u}_{11} & {u}_{12} & … & {u}_{1 n} \\ {u}_{21} & {u}_{22} & … & {u}_{2 n} \\ ⋮ & ⋮ & ⋱ & ⋮ \\ {u}_{m 1} & {u}_{m 2} & … & {u}_{m n}\end{matrix} ] = [ \begin{matrix}( \begin{matrix}⋮ \\ {U}_{1} \\ ⋮\end{matrix} ) & ( \begin{matrix}⋮ \\ {U}_{2} \\ ⋮\end{matrix} ) & … & ( \begin{matrix}⋮ \\ {U}_{n} \\ ⋮\end{matrix} ) ]\end{matrix} ,$$

$${U}_{1} = ( \begin{matrix}{u}_{11} \\ {u}_{21} \\ ⋮ \\ {u}_{m 1}\end{matrix} ) , {U}_{2} = ( \begin{matrix}{u}_{12} \\ {u}_{22} \\ ⋮ \\ {u}_{m 2}\end{matrix} ) , … , {U}_{n} = ( \begin{matrix}{u}_{1 n} \\ {u}_{2 n} \\ ⋮ \\ {u}_{m n}\end{matrix} )$$

Each column Uᵢ is placed in descending order according to the magnitude of the corresponding singular value σᵢ, such that σ₁>σ₂> . . . >σₘ. In other words, the columns of U are simply the left singular vectors of A ordered according to their relative importance in describing the dataset A.

On the right-hand side of the SVD product sits the n×n matrix V^{T} of the right singular vectors transposed such that the i^{th} row

$${V}_{i}^{T}$$

corresponds to the transpose

$${V}_{i}^{T} = {v}_{i}^{T}$$

of the i^{th} right singular vector vᵢ. Note again that, as shown below, the transposed right singular vectors are placed in descending order of importance according to the magnitude of their corresponding singular values.

$${V}^{T} = {[ \begin{matrix}{v}_{11} & {v}_{12} & … & {v}_{1 n} \\ {v}_{21} & {v}_{22} & … & {v}_{2 n} \\ ⋮ & ⋮ & ⋱ & ⋮ \\ {v}_{n 1} & {v}_{n 2} & … & {v}_{n n}\end{matrix} ]}^{T} = [ {\begin{matrix}( \begin{matrix}⋮ \\ {V}_{1} \\ ⋮\end{matrix} ) & ( \begin{matrix}⋮ \\ {V}_{2} \\ ⋮\end{matrix} ) & … & ( \begin{matrix}⋮ \\ {V}_{n} \\ ⋮\end{matrix} ) ]\end{matrix}}^{T} = [ \begin{matrix}( … {V}_{1} … ) \\ ( … {V}_{2} … ) \\ ⋮ \\ ( … {V}_{n} … )\end{matrix} ]$$

$${V}_{1} = ( \begin{matrix}{v}_{11} \\ {v}_{21} \\ ⋮ \\ {v}_{n 1}\end{matrix} ) , {V}_{2} = ( \begin{matrix}{v}_{12} \\ {v}_{22} \\ ⋮ \\ {v}_{n 2}\end{matrix} ) , … , {V}_{n} = ( \begin{matrix}{v}_{1 n} \\ {v}_{2 n} \\ ⋮ \\ {v}_{n n}\end{matrix} )$$

Both the matrices U, V are unitary matrices, such that UU^{T}=U^{T}U=I_{m×m} and VV^{T}=V^{T}V=I_{n×n} respectively, where I_{l×l} is the l-dimensional identity matrix.

### Singular Values Matrix (Σ):

The matrix in the middle of the SVD product is the matrix Σ containing the singular values of A. This matrix is diagonal and sparse, whose only elements are the positive singular values {σᵢ} placed on the leading diagonal.

$$\sum = [ \begin{matrix}{σ}_{1} & 0 & … & 0 \\ 0 & {σ}_{2} & … & 0 \\ ⋮ & ⋮ & ⋱ & ⋮ \\ 0 & 0 & … & {σ}_{n} \\ 0 & 0 & 0 & 0 \\ ⋮ & ⋮ & ⋮ & ⋮\end{matrix} ]$$

As with U and V^{T}, the elements of Σ are ordered hierarchically. The singular values are placed on the diagonal in descending order of magnitude, such that σ₁≥σ₂≥ . . . ≥σₙ≥0. Since Σ has dimensions m×n, it only contains the first n singular values along this diagonal and everything below it is zero. As noted previously, in practice this matrix will contain r≤min (m,n) non-zero diagonal entries, where r is the rank of A.

### Matrix Expansion:

Finding the SVD of a data matrix A also allows us to write the series expansion of A as the sum of component matrices

$${σ}_{i} {U}_{i} {V}_{i}^{T} .$$

The expansion of A, assuming n non-zero singular values, is written in terms of these matrices as follows:

$$A = {σ}_{1} {U}_{1} {V}_{1}^{T} + {σ}_{2} {U}_{2} {V}_{2}^{T} + … + {σ}_{n} {U}_{n} {V}_{n}^{T} = {\sum }_{i = 1}^{n} {σ}_{i} {U}_{i} {V}_{i}^{T}$$

Each term in the summation is a rank-1 matrix formed from the outer product

$${U}_{i} {V}_{i}^{T}$$

of a left singular vector Uᵢ and corresponding right singular vector

$${V}_{i}^{T} .$$

Note that the expansion of A as a sum of these rank-1 matrices is exact and does not lose any information about A.

### Matrix Approximation:

The expansion of A as the sum of rank-1 component matrices can be used to approximate the original matrix A by removing the ‘least-important’ terms of the expansion. We denote such an approximation by Ã or A≈Ũ\tilde{Σ}\tilde{V}^{T}.

Since the SVD places singular values and vectors in order of descending influence on the original matrix A, the matrix expansion of A also preserves the ordering. This means that the first terms (i=1, 2, . . . ) of the matrix expansion have the most influence in describing the dataset within A, while the last terms (i= . . . , n−1, n) have the least influence.

Using this fact, we define the rank-r approximation (or truncation) of A as the matrix expansion of A containing the first r terms only, as illustrated in FIG. 8, which provides a visualisation of the rank-r approximation of a matrix A.

For readability, we herein denote the rank-r approximation of A as Ãᵣ=[Ũ\tilde{Σ}\tilde{V}^{T}]ᵣ. In this approximation, Ũ, \tilde{V} contain the first r columns of U, V respectively and E denotes the first r×r block of Σ. The discarded n−r terms of the expansion are referred to as the remainder of the approximation.

As known in the art, the Eckart-Young theorem states that the optimal rank-r approximation of A is given by the rank-r truncated SVD of A. As a result, the SVD truncation method is widely used for dimensionality-reduction of datasets. This enables a data matrix A, encoding measurements in a large m-dimensional space, to be projected into a lower r-dimensional subspace which captures the main features of the dataset with minimal loss. Because this low-dimensional representation of A will generally be less computationally expensive to work, the SVD forms the basis for dimensionality-reduction techniques such as principal components analysis (PCA) used to prepare large datasets for use in machine learning applications.

### The Economy SVD:

An m×n data matrix A, with m>n, has at most n linearly independent columns. This means that, at most, only the first n columns of U in the SVD(A) are required to encode A exactly. The remaining m−n columns of U, denoted by can be removed from the SVD without losing any information about the original dataset. We denote the first n columns by Û and the remaining m−n columns by Û^{⊥}.

Similarly, only the first n rows of Σ contain any non-zero entries. This means that only these first rows, denoted \hat{Σ} are required to reconstruct A from its SVD without loss of information.

Using these facts, we can define the economy SVD as:

Â=Û\hat{Σ}V^{T}

FIG. 9 provides an illustration of the relationship between the economy SVD and matrix approximation by truncation. It should be noted that the economy SVD is exact, meaning that Â=A, which can be seen in the following:

$$A = U \sum {V}^{T} = [ \begin{matrix}\hat{U} & {\hat{U}}^{⊥}\end{matrix} ] [ \begin{matrix}\hat{\sum } \\ 0\end{matrix} ] {V}^{T} = \hat{U} \hat{\sum } {V}^{T} + \hat{A}$$

$$∴ U \sum {V}^{T} = \hat{U} \hat{\sum } {V}^{T}$$

The relationship between the standard SVD, the economy SVD, and the truncated SVD is shown schematically in FIG. 9. We see that the economy SVD Â removes extraneous information from the standard SVD, without loss of information, while the truncated SVD A removes further information (columns and rows) from the SVD matrices to approximate A at the cost of introducing some error.

### Image Compression:

The singular value decomposition can be used as an image compression technique. This exploits the hierarchy of terms in the series sum expansion of the SVD, whereby the first r terms in the expansion can be used to approximate the original image, and the remainder discarded.

Consider an image represented as an m×n matrix A, where m is the height of the image in pixels and n is the width of the image in pixels. Taking the SVD of A will give us the usual product matrices U, Σ, V^{T} which can be truncated to approximate the original image.

The columns of U represent dominant features in the original image and form a basis for the (1×m)-pixel columns of the original image A. Similarly, the rows of V^{T} form a basis for the (1×n)-pixel rows of the image. Each column in V^{T}, scaled by the singular values in Σ, specifies the precise linear combination of the columns of U that can be used to recover the corresponding original column of pixels in A.

We can e t the complete original image matrix A as the series sum of rank-1 matrices

$${σ}_{i} {U}_{i} {V}_{i}^{T}$$

formed by each successive column Uᵢ, row

$${V}_{i}^{T} ,$$

and singular value σᵢ. In the context of image compression, we term these matrices

$${A}_{i} = {σ}_{i} {U}_{i} {V}_{i}^{T}$$

the ‘components’ of the original matrix A. This is not to be confused with the components referred to in the art as Principal Component Analysis.

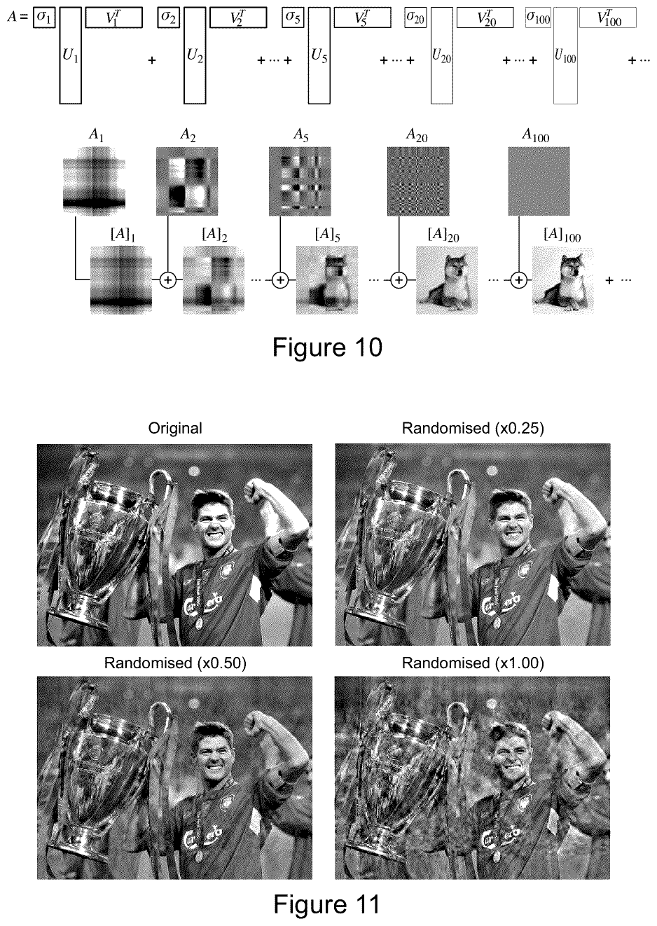

From these components, we can define the rank-r compression of A as the rank-r approximation [A]ᵣ, such that C(A)=[A]ᵣ using our previous notation [A]ᵣ=Ãᵣ=[Ũ\tilde{Σ}\tilde{V}^{T}]ᵣ. In other words, the rank-r approximation is the sum of the first r components of the image [A]ᵣ=A₁+A₂+ . . . +Aᵣ, as shown in FIG. 10. FIG. 10 provides the SVD expansion of an image to illustrate how an image can be approximated by keeping the first r terms in the expansion.

It should be noted that, while the Eckart-Young theorem tells us that [A]ᵣ is the optimal rank-r approximation of the original matrix, this is a lossy approximation. This means that the SVD-based compression of an image can be interpreted as the optimal way to represent a lower-fidelity version of the original image using a lower r-dimensional basis, not that it is the optimal way to compress the original image without loss.

### DETAILED DESCRIPTION—OF ILLUSTRATIVE EMBODIMENTS OF THE DISCLOSURE

With reference to the accompanying Figures, we now disclose preferred embodiments and aspects in respect of a novel approach to creating, controlling, transferring and securing tokenised assets via a blockchain.

For the sake of convenience and ease of reference only, we may sometimes refer hereafter to Non-Fungible Tokens (NFTs) and associated schemes as these provide a well-known and therefore readily understood context for one or more illustrative embodiments. However, the disclosure is not limited with regard to this illustrative use case and other tokenisation schemes can be used with the techniques disclosed herein.

Embodiments disclosed herein may provide new design paradigms for digital tokens and token-based schemes that are based on or utilise the singular value decomposition (SVD). These aspects can be combined with one another in a variety of ways to provide new blockchain-based tokenisation schemes, depending on a particular implementation or use case.

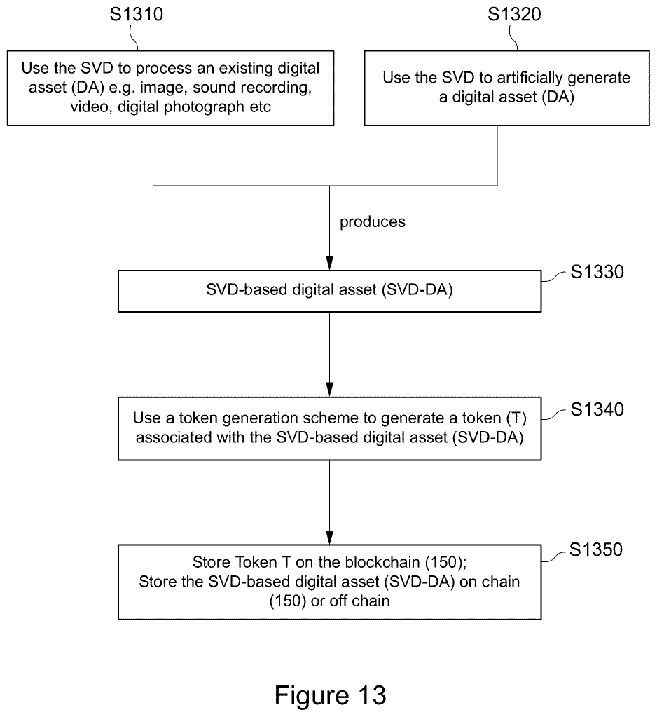

With reference to FIG. 13, preferred embodiments comprise the generation of a SVD-based digital asset. An SVD-based digital asset (SVD-DA) may be described as a digital asset that has been generated using the SVD. There are different approaches that can be used for this purpose and are outlined below (see algorithms 1, 2 and 3). These can be considered a form of ‘generative’ tokenisation protocol.

In the first (‘image-first’) approach of algorithms 1 and 2, this is achieved by using SVD to process one or more existing digital assets (S1310). In an alternative (‘SVD-first’) approach of algorithm 3, this is achieved by using the SVD to artificially generate a digital asset from scratch (S1320).

Whichever of these two approaches is used, the result is that an SVD-based digital asset is produced (S1330). In other words, Singular Value Decomposition has been used in the creation of a digital asset the represents some physical, virtual or digital entity/resource.

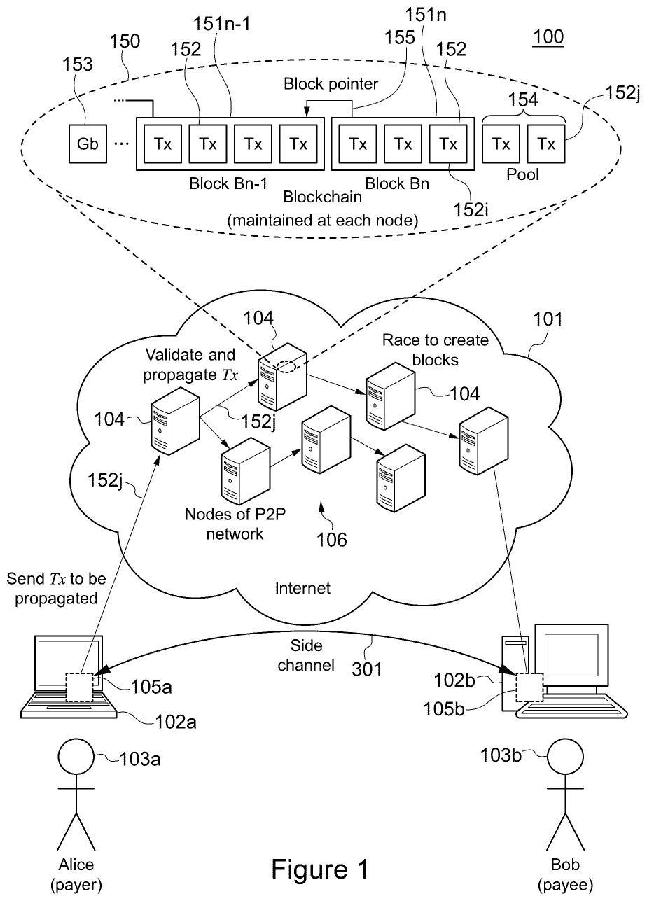

A chosen tokenisation scheme can then be used to generate a token that comprises, is associated with or is representative of the SVD-based digital asset (S1340). With particular reference to FIGS. 1 to 4, and the section below entitled “example system overview”, the token can then be submitted to the nodes (104) a blockchain network (106) as part of a blockchain transaction (152).

The nodes (104) will then perform their verification and mining functions and, if not rejected by the nodes, the transaction comprising the token will be written to the blockchain (150) as part of a block (151). The token may, be provided in the output (203) e.g. UTXO of the transaction, and/or may be provided as metadata within the transaction (152).

The tokenisation scheme can comprise any suitable protocol and may typically be selected in accordance with the requirements of a given implementation. In some cases, the chosen tokenisation scheme may be an NFT protocol which will enable the generation and processing of one or more NFTs. Implementations which use the disclosed embodiments in conjunction with an NFT protocol will, therefore, generate and process SVD-based NFTs.

### Structure of the Digital Asset

Embodiments of the disclosure provide solutions that represent, generate and manipulate tokenised digital content (e.g. NFT images) using the singular value decomposition. The illustrative embodiments provided herein provide a range of different ways in which this can be achieved.

Without limitation, two generalisations of the possible approaches can be described as follows:

### 1. Image-First Approach:

here, we start with an initial digital entity (such as an image, digital artwork etc.), take its SVD, modify the components of the SVD in some way, and construct a new entity (or entities) based on the original by multiplying together the modified SVD matrices.

### 2. SVD-First Approach:

here, we start by artificially constructing the elements of an SVD which is not based on an original digital entity (e.g. a digital image), and generate a derivative (e.g. an NFT image) by multiplying together the SVD matrices.

These general approaches can be applied to both individual digital assets or to collections of digital assets. These are described in more detail below.

### 1. THE ‘IMAGE FIRST’ APPROACH

The approach to generating SVD-based tokens from existing digital assets is explained in the two algorithms that follow in this section, with reference to the accompanying figures, and FIG. 7 in particular. In our examples, we will use digital images as our initial digital assets for illustration only, although the disclosure is not limited in this regard. The terms ‘initial’, ‘original’ and ‘existing’ may be used interchangeably herein.

In algorithm 1, a single original image is used as the starting point for the SVD operations. Many different versions of a new image can then be generated from this base asset.

In algorithm 2, a collection of original images is used as the starting point for calculations, from which it is possible to derive a generator matrix that can create a wider variety of new images. Both algorithms may comprise the step of generating the data matrix A that represents or is based on the initial digital asset(s) that are to be tokenised, so that the SVD matrices of A can then be obtained.

Algorithm 1: Generating an SVD-Based Asset from a Single Initial Digital Asset

In a preferred embodiment, the algorithm to generate an SVD-based digital asset that is based on a single initial image may comprise the following steps:
1. Represent the initial image as an m×n matrix A
2. Obtain the SVD matrices: U, Σ, V^{T}←SVD(A)
3. Modify some of the elements of U′, Σ′, V^{T}′←M(U, Σ, V^{T})
4. Generate the new image from the new matrices: A′←U′Σ′V^{T}′

The matrix dimensions m and n are the height and width of the initial image respectively, measured in pixels. This means that step 1 can be considered a direct mapping of pixels from the original two-dimensional image onto the (spatially) corresponding entry of A. For example, the value of the top-left pixel in the original image is placed in the entry a_{0,0} and the value of the bottom-right pixel is placed in a_{m,n}. In examples that use different types of initial digital assets other than images, other appropriate metrics and attributes can be used to map the initial asset to its data matrix A. It should be noted that m n is a valid choice form×n matrices. Therefore, embodiments herein are not limited to only cases where m≠n.

The function M( ) used in step 3 is a modification function that acts on (modifies) at least one of the three original SVD matrices U, Σ, V^{T}. For simple notation, we choose to always write this step as M(U, Σ, V^{T}), even if M has no effect on one or two of the three matrices. As only a minimum of one of the three matrices needs to be modified, it is possible that, for example, U′=U if U is not the modified matrix.

Numerous examples of such functions can be devised including, for example, modifications that comprise arithmetic functions, Boolean operations, bitwise operations etc. The choice of modification function will impact the resulting matrix. With reference to our earlier description on image compression, modifying each matrix will have the following effects:
U—this matrix contains hierarchical feature(s) that form a basis for the columns of A. By altering one of these features, the resulting matrix will also have different basic features in its columns. Altering a dominant feature (e.g. U₁ or U₂) will have a significant impact on the resulting image, which may cause it to lose semblance to the original. However, altering the less dominant features will allow the resulting image to retain similarity to the original with subtle differences, which may be more desirable.
V^{T}—similarly, this matrix contains a hierarchical feature basis for the rows of A.

The same considerations as for the columns of U therefore apply to modifying the rows of V^{T}.
Σ—this matrix scales the dominance of the row and column features present in the resulting image. Modifications to the diagonal elements of Σ will therefore change the relative dominance of the columns of U and rows of V^{T} in the resulting image A′.

In some cases, a different modification operation M( ) can be used for the modification of respective matrices in the SVD. In other cases, the same modification operation could be used to modify different SVD matrices but with the use of different, respective operands. In other embodiments, the modification step (step 3) could comprise the use of more than one modification function.

An example of using this method to generate a new blockchain-based token is shown in FIG. 11 which provides three examples of a new digital asset (image) A′ generated by randomly modifying the singular values in the SVD of an original asset (image) A. Each example applies a different degree of randomness to the original Σ matrix. In this way, a random or pseudo-random modification operation can be used in which the modification of the SVD product matrices is influenced by a random or pseudo-random factor or value.

In this example the modification function used simply applies a random scaling to each singular value of the original Σ matrix. In each example we have further applied a uniform scaling to the randomness (of 0.25, 0.5 and 1 respectively) to illustrate the different effects on the derived image in each case. In an alternative embodiment, a non-uniform scaling of the randomness may be chosen. For example, this may be proportional to the index of the singular value.

When modifying the SVD matrices of the original image, we have two options:

### 1. Randomisation:

we can apply randomness to the existing elements of the SVD matrices to produce a new image that is akin to a random perturbation of the original. For example, a random or pseudo-randomly generated value can be use as an operand to the modification function M( ) that operates on at least one of the original SVD matrices U, Σ, V^{T}. Different random values/operands can be used for each of a plurality of modification operations M( ) or each of the matrices/singular values that are modified.

### 2. Substitution:

we can substitute elements of the existing SVD matrices. This may be done at the level of individual elements (such as singular values in Σ) or at the level of entire vectors (columns of U or rows of V^{T}). In this approach, a substitution operation may replace one or more singular values by another value.

In some embodiments, the choice of which of the two options to use may be based on or influenced by the properties of the original image. These may comprise, for example, its dominant features, structure, and/or resolution.

Advantageously, the substitution method allows for specific features to be introduced to the new SVD matrices, which may give higher a degree of control over the resulting SVD-based image generated by them (and subsequently used by the token generation protocol). In accordance with one or more embodiments, any combination of randomisation and substitution of elements may be used in respect of the SVD matrices.

### Modification Function

In accordance with one or more embodiments disclosed herein, if a blockchain-based token (e.g. NFT) is generated using a modification function M a link can be established from the source image(s) and the derived image by also attesting to the function itself and any parameters used when generating the new NFT. In other words, a verifying party e.g. a new controller of a token or SVD-based digital asset, can be provided with the modification operation(s) and parameter(s) used to generate them. The verifying party can apply the specified modification operation(s) to the original version, and check that they arrive at the SVD-based version that they have obtained.

The parameters used for a modification may include a seed that can be used to derive pseudo-random numbers for randomising elements in the SVD product matrices of the source. This additional attestation would allow new owners/recipients/controllers to independently derive the new NFT, given the source asset(s) and M, and verify that the NFT they have received was generated as expected. Therefore, methods of the disclosure can comprise the step of providing a blockchain-based token and data associated with the generation of that token to a recipient; and then verifying, by the recipient, the authenticity and integrity of the token they have obtained.

### Generating Randomness

In one or more embodiments disclosed herein, the randomness used to modify SVD matrices when generating a new token can be derived from the blockchain itself. In this case, the token scheme would need to pre-define the unpredictable source of this randomness ahead of time, such as “the block hash at height T+X”, where T is the current block height and X is an integer. In this way, SVD-based tokens can embed the blockchain itself into their generation process which time-stamps their creation. Any party needing to verify the authenticity, provenance, history or ownership of a tokenised digital asset can do so.

Algorithm 2: Generating an NFT from an Image Collection:

In accordance with this embodiment of the disclosure, we start with a set of initial digital assets rather than a single one as per Algorithm 1. In accordance with Algorithm 2, the data matrix A is generated in a different way. In this second approach, each column in the data matrix A represents or derives from a respective initial digital asset.

Recall from above that SVD can be used to “express a data matrix as a product of matrices which reveal the key features of the data contained in A and can be used to approximate A with minimal information loss”. This aspect of SVD is exploited in Algorithm 2 by selecting the common features of the set of images in represented in the matrix, in a fashion similar to the use of eigenfaces as described above.

In a preferred embodiment, the algorithm to generate an SVD-based digital asset based on a plurality of initial digital assets (which we may refer to as an ‘initial image/asset collection’) may comprise the following steps:
1. Represent the set of k initial images as an l×k matrix A
2. Obtain the SVD product matrices: U, Σ, V^{T}←SVD(A)
3. Choose a k×1 column vector

$${V}_{⊥}^{T}$$

4. Generate the new image column vector:

$${A}_{⊥} ← U Σ {V}_{⊥}^{T}$$

5. Reshape A_{⊥} into the new image: A′←R(A_{⊥})

In the above, the column vector V_{⊥}^{T} is not based on the SVD matrices of matrix A. Instead, it is a newly chosen selection of values, provided as a column vector.

It can be seen that, compared to Algorithm 1, the difference with Algorithm 2 is that a single column vector is selected, and the initial digital asset is reshaped to provide a new one. In particular, steps 3 and 5 of Algorithm 2 differ from Algorithm 1.

In this second approach, the collection matrix A consists of k column vectors of length l=m·n. Each column vector provides the reshaping of an m×n initial image, where m and n are the height and width of initial images respectively, measured in pixels.

Performing the SVD of the collection A extracts the “eigen-features”, stored in the columns of U which form a basis for representing the initial collection of images. The column vector

$${V}_{⊥}^{T}$$

in step 3 is a choice of k coefficients that will take a linear combination of these basis features to form the new image column vector A_{⊥} in step 4. In other words, the new l×1 vector A_{⊥} is simply a linear combination of the eigen-features of the initial image data set.

The final step is to reshape A_{⊥} into an m×n matrix A′ which represents the new SVD-based image. The function R( ) is used to denote this reshaping process.

To ensure there are coherent eigen-features to extract from the initial matrix A, the set of initial images in the collection should be similar. This condition is satisfied in most token/NFT collections, which typically are already generated by randomly selecting from a set of pre-defined features.

In one or more embodiments, a modification step could also be applied to the above procedure, similar to step 3 in the previous algorithm, where the elements of either or both of U and Σ could be modified. As in the previous case, these modifications could comprise a combination of random and/or substitutive.

If based on an initial collection where the features are very well-defined, it may be advantageous to preserve the singular values to ensure the relative dominance of each feature is retained, and the selection vector

$${V}_{⊥}^{T}$$

simply chooses them in a new combination to form the new digital image (asset).

### Generating Token Collections

Both methods described above can be used to generate a set of SVD-based digital assets based either upon a single initial image or an entire existing digital asset collection. The terms ‘set’, ‘collection’ and ‘plurality’ may be used interchangeably herein.

In the first case, to generate a new collection from a single image, we would simply repeat steps 3 and 4 of algorithm 1 multiple times, using a different modification in step 3, to create as many new SVD-based digital assets (e.g. images) as required. The step of repeating the modification may comprise using a different modification function M( ) and/or using different operands to the function.

In the second case, to generate a new collection based on an existing collection, we would similarly repeat steps 3-5 as many times a required, where a different selection vector

$${V}_{⊥}^{T}$$

is chosen each time.

### 2. THE ‘SVD-FIRST’ APPROACH

By contrast to the approach described above, embodiments in accordance with the SVD-first approach do not start with any initial asset (e.g. image) data to work from. This means that only one asset-generation algorithm needs to be specified rather than the two possible options described above in respect of the image-first approach.

Algorithm 3: Generating Digital Assets from A Chosen SVD

In this approach, shown in S1320 of FIG. 13, at least one SVD-based digital asset is generated from an artificially constructed SVD rather than from an existing digital asset or assets. The base features that are used to form the matrices can be chosen by or otherwise obtained from the user according to the needs and requirements of a particular use case, implementation or application.

In this sense, the SVD that the token/asset is subsequently obtained from can be described as ‘user specified’ in that the user specifies at least one or more of the elements of the initial data matrix (A) rather than them being dictated by an asset or some other entity. In this approach, the user (at least partially) designs and constructs the SVD product matrices UΣV^{T} rather than them being derived from some other asset/entity such as an image.

This provides the user with complete freedom of choice to specify the features of the asset that will be used subsequently by the tokenisation protocol of the user's choosing. Thus, a fully customised and specified token can be generated, comprising properties and attributes chosen specifically for a given purpose.

Advantageously, such an approach facilitates the construction of an SVD that multiple users contribute to. For example, one user may contribute one set of basis features, while another party contributes a further set of features. The resulting SVD (and thus token) is formed, therefore, as the collaborative product of multiple contributors. Each contributor may have a share of the resulting token. Consider a scenario in which multiple artists are involved in a performance, or a painting is composed of layers or components contributed by different artists. Consider another example scenario in which a contract or will is signed by multiple parties who provide signatures to a document. A matrix can be formed using each contributor's input as basis feature(s) that are then combined via the SVD-based approach to form a one or more tokenised assets that are then implemented on the blockchain.

It should also be noted that other operations can be performed on the data matrix and/or SVD product matrices as discussed in respect of other embodiments herein. For example, modification, approximation and/or encryption operations can be applied to the data matrix and/or SVD matrices.

Advantageously, this can result in numerous benefits including but not limited to, reduced risk of counterfeiting and other types of fraud, exploitations etc., for example, because the user can design the asset with one or more attributes that are known only to the user, and not discernible, reproducible and/or predictable to an unauthorised party. In other situations, an existing digital asset may not be available, possible or desirable for a variety of potential reasons. In such cases, the disclosed SVD-first approach enables a more versatile, secure and flexible tokenisation technique.

An illustrative algorithm formed in accordance with such an embodiment may comprise the following steps:
1. Define a set k basis features, Fᵢ, each as an m×n matrix
2. Reshape each feature matrix into an l×1 column vector: Uᵢ←R⁻¹(Fᵢ)
3. Form an l×k matrix U that uses Uᵢ as its columns
4. Choose a set k of singular values σ₁, . . . , σₖ
5. Form a k×k diagonal matrix Σ with σ₁, . . . , σₖ on its diagonal
6. Define a set of N selections as k×1 column vectors

$${V}_{i}^{T}$$

7. Form an k×N matrix V^{T} that uses

$${V}_{i}^{T}$$

as its columns
8. Generate a collection matrix: A←UΣV^{T}
9. Reshape each column Aᵢ to generate a new image R(Aᵢ)

In the above, using our image-based example again, m and n are the pixel height and width of the output digital assets, and N is the desired number of SVD-based digital assets. A single SVD-based digital asset may be generated by setting N=1, and a collection by setting N>1. The function R⁻¹( ) denotes the inverse of the reshaping function R( ) defined earlier.

### Singular Values:

In accordance with one or more embodiments, the singular values can be freely chosen in this algorithm. However, in some implementations a hierarchy of features may be required. For example, there may be a need to denote that the resulting token or its associated asset belongs to a hierarchy such as VIP tickets versus priority tickets versus standard tickets, or first edition artworks versus re-prints etc. In such cases, the singular values can be chosen to reflect this. The columns of U and diagonal entries of Σ should also be reordered to match the corresponding hierarchy.

### Binary Feature Selection:

In accordance with one or more other embodiments, the algorithm can be modified to allow binary feature selection, in the sense that each feature Uᵢ is either present (‘True/1’) or absent (‘False/0’) in a particular image column Aⱼ. This can be implemented by removing the hierarchy from the SVD, such that all singular values are defined to be σ₁= . . . =σₖ=1, and the components of each

$${V}_{j}^{T}$$

are set to either 1 or 0. If a feature Uᵢ is present in A₁ the element Vᵢⱼ=1, otherwise Vᵢⱼ=0.

### SVD Matrix Encryption

In accordance with another aspect, embodiments of the disclosure provide techniques for SVD-based generation of digital assets that can be used to create and transfer tokens (including NFTs) with a greater degree of privacy, security and control, for the original controller.

The two key ideas are as follows:
User-specific matrices:
a token can be transferred multiple times to different users. Each time it is transferred, the user receives a modified version of the token where one or more elements of the SVD have been manipulated (modified) based on a selected feature or variable such as the recipient's unique identifier, or a unique token version, or a time stamp of the transfer, a recipient address etc. This provides a customisable tokenisation scheme that is more secure because it can allow for verification of authenticity of sender and/or receiver, thus reducing the likelihood of counterfeiting or fraud or unauthorised access/interception. Embedding this transfer-specific data into the generated digital asset itself enables the provenance and history of the token to be verified, and provides the verification data as an integral part of the asset itself. Moreover, there is no additional resource cost for storing or sending the verification data separately.
Encrypted transfer:
before the token is transferred from the initial controller to a new recipient, the matrix is encrypted element-wise using a key that can be derived by the recipient to decrypt the matrix. Again, this provides a more secure encryption and transfer solution for blockchain-based tokens and/or their digital assets, as the encryption is implemented at the element level of the matrix.

Each of these concepts can be used separately, in isolation. However, in combination they allow us to implement the transfer of SVD-based token/asset data in a more secure way. Making each matrix specific to a given user (i.e. each recipient of the NFT) ensures that each individual purchase of the base NFT is provably linked to the recipient. Using encryption to transfer the actual data of the user-specific NFT matrix ensures that only the intended recipient can reconstruct the resulting NFT.

Consider an initial controller (owner) Alice, who has minted a base token A, and a recipient Bob who wishes to obtain control (e.g. ownership) of a version of the token that is specific to him A_{B}.

The following examples uses NFTs for illustration purposes only. Other types of tokens may be used instead.

The protocol Alice can use to transfer such a version to Bob may comprise the following steps:
1. Alice generates the base NFTA
2. Alice obtains the SVD matrices for A: U, Σ, V^{T}←SVD(A)
3. Bob sends Alice some information that uniquely identifies him (e.g. a public key PB)
4. Alice modifies the base NFT matrices:

$${U}_{B} , {\sum }_{B} , {V}_{B}^{T} ← M ( U , Σ , {V}^{T} )$$

5. Alice generates Bob's new NFT matrix:

$${A}_{B} ← {U}_{B} {\sum }_{B} {V}_{B}^{T}$$

6. Alice and Bob generate a shared secret s between them
7. Alice encrypts Bob's NFT matrix using the shared secret: E_{B}←Encrypt(A_{B}, s)
8. Alice sends E_{B} to Bob
9. Bob decrypts to recover his NFT: A_{B}←Decrypt(E_{B},s)

The step of generating the matrix for base token A is implicit in the above. The data matrix for A will be obtained before Alice can obtain the SVD (i.e. the plurality of matrices) in step 2.

Generation of the user-specific matrix A_{B} in step 5 involves multiplying the SVD matrices back out to obtain the modified version of the base matrix A. It also uses a modification function M as used previously in algorithms 1, 2 and 3 described above. In this embodiment, though, the randomisation and/or substitutions made by M will use Bob's unique identifying information as a parameter. For example, if the information is Bob's public key P_{B} then this can be used as a seed to apply a random perturbation to the elements of U,Σ,V^{T}. In some embodiments, Alice may send an unencrypted version of Bob's new matrix A_{B}, or a SVD-based digital asset that is based on the new matrix, or a blockchain-based token that is generated using it.

Assuming, however, that Alice chooses to send an encrypted version, Alice and Bob generate a shared secret s in step 6. In one approach, this can be a shared symmetric key derived using a Diffie-Hellman process (such as disclosed in WO 2017/145016 which is incorporated herein in its entirety). Using this symmetric key, the resulting matrix A_{B} can be encrypted using and suitable encryption technique. For example, this could be a block cipher, such as disclosed in International applications PCT/EP2023/053998 or PCT/EP2023/053862 which are incorporated herein in their entirety. In other embodiments, a (symmetric) stream cipher may be used, where each element of A_{B} is encrypted in turn to generate E_{B}. In such as case E_{B} will simply be a matrix whose elements are the encrypted elements of A_{B}, and E_{B} can be sent directly to Bob to be decrypted using s.

Token collections are often described as 1-of-N collections when there are N ownable copies of an identical token collection. Therefore, in some embodiments, there may be multiple recipients and multiple corresponding transfers.

Other features and embodiments outlined herein can be combined with this protocol to provide further variations and embodiments. For instance, a low rank thumbnail [A]ᵣ of the base token can be the only version published by Alice (see section below relating to ‘thumbnails’).

### Use-Case Examples

We now provide examples of use cases in which embodiments disclosed herein can be used to advantage. These are provided to illustrate the versatility of the techniques disclosed herein, and some of the technical benefits that the disclosed embodiments can provide.

### Non-Fungible Tokens (NFTs)

The techniques outlined above are compatible with any existing tokenisation protocol, given that they concern how the new digital content is created rather than how a token scheme could use these results. Therefore, the disclosed techniques are agnostic to the way in which the tokens are used after their creation.

However, an example use case that the disclosure is well suited for is in the design, generation and processing of tokenisation techniques known as Non-Fungible Tokens (NFTs). Wikipedia describes an NFT as “a unique digital identifier that cannot be copied substituted, or subdivided, that is recorded in a blockchain, and that is used to certify ownership and authenticity”—see en.wikipedia.org/wiki/Non-fungible_token. Like a passport, each NFT token has a unique and non-transferable identifier which distinguishes it from other NFTs. The NFT is a digital, on-chain representation of a (physical, virtual or digital) asset, or part thereof, such as an artwork, a piece of digital content such as video or an image, a pair of shoes, an individual's identity, a domain name etc. Perhaps the widely known use of NFTs is to denote and prove attest to ownership of the represented asset.

NFTs use so-called ‘smart contracts’. Rather than being legally-enforceable contracts, smart contracts are machine-executable programs comprising logic code that specifies how the NFT is created (‘minted’) and how it can be managed e.g. transferred from one owner to another. IF-THEN statements in the NFT's logic code specify condition(s) and actions that will be taken if respect of the NFT if the condition(s) are met. In some cases, the NFT is stored entirely on the blockchain, such that the smart contract, NFT identifier and metadata and the associated, tokenised digital asset are stored on-chain. In other cases, as explained elsewhere herein, the digital asset that the NFT represents may be stored off-chain.

Embodiments of SVD-based tokens as disclosed herein enable new functionalities and various improvements of existing NFT schemes. For example, in some sense, the ‘SVD-first approach’ of Algorithm 3 above, can be considered as analogous to the concept of ‘layering’ used in many generative NFT collections, where each NFT is a combination of variable pre-defined features that are overlayed on one another. In accordance with embodiments of the present invention, the ordering of layers can be encoded in the magnitude of the singular values of an SVD-based NFT.

While not limited to use with NFT schemes, the use cases, applications and benefits provided below are applicable to NFT applications and implementations.

### Thumbnails

A key challenge for many tokenisation schemes is the high number of resources that can be required if data relating to the digital asset itself is to be stored on the ledger. Moreover, some blockchain protocols impose limitations on how, and how much, data can be stored in their transactions. Storing data on the ledger provides numerous technical benefits such as, for example, a time-stamped and immutable record of when the data was stored and by whom, and cryptographically enforced access control of that data thereafter. However, if a token represents a digital asset that comprises a significant amount of data, it may not be possible to store that data on-chain depending on the relevant protocol or, even if it is, it may not be economically or technically desirable to do so.

Using NFTs as an example, a significant number of costs (e.g., storage, processing, cryptocurrency) can be consumed when including NFT image data natively on-chain alongside the NFT logic itself. This means that it is often impractical to store the token data itself on the blockchain ledger, and has led to many token schemes relying on auxiliary networks, such as IPFS, or third parties to store the actual token content. The off-chain data then has to be linked via a URL to associate it with the token on the blockchain. Thus, the on-chain token is separated from the data relating to the asset that the token represents, in an attempt to reduce the resources required for online storage and processing.

However, such an approach has been known to cause technical issues, such as how to preserve the association between the token and its associated asset data. For example, the linked data could be altered or even removed after control of the token is transferred to a new recipient, or ‘link rot’ can occur when the URL no longer points to the correct location of the data. In such cases, the data can become inaccessible. Therefore, challenges exist relating to at least the technical fields of digital preservation, data permanence and data persistence.

Advantageously, embodiments as disclosed herein provide enhanced and improved alternatives that, among other benefits, address the problem of storage and processing resource requirements for blockchain-based tokenisation. Rather than storing the entire, raw data on the blockchain, a low-rank approximation [A]ᵣ can be stored on-chain instead. This can be thought of as an on-chain ‘thumbnail’ for the asset e.g. an NFT image which can be represented using significantly less data and therefore requiring fewer resources for storage in the ledger.

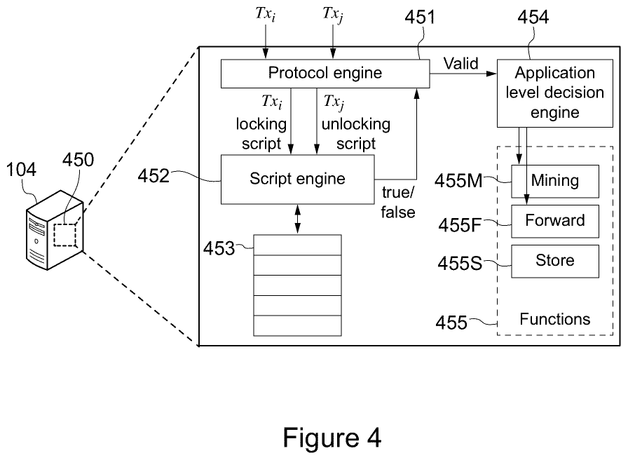

With reference to FIGS. 4, 5 and 6, such an embodiment may comprise using a low rank approximation [A]ᵣ of a digital asset that has been generated substantially as described above in sections entitled “Singular Value Decomposition (SVD)” and “Image Compression”, and then using the low rank approximation to generate a SVD-based digital asset. The SVD-based digital asset can be used to generate a blockchain-based token such as an NFT. Advantageously, as the token's associated asset data requires fewer resources de to its approximation, it can be stored on the blockchain in the same or different transaction(s) as the other token-related data.

Therefore, using our example of a digital image as the asset, where m is the height of the image in pixels and n is the width of the image in pixels, such an embodiment may comprise one or more of the following steps:
1. Generating a m×n data matrix A for a digital asset
2. Obtaining the SVD of A, to provide the product matrices U, Σ, V^{T}
3. Truncating one or more of the product matrices to approximate the digital asset.

Step 3 above may comprise steps substantially as described in the section above entitled “The Economy SVD”. Therefore, after the truncation operation of step 3, the product matrices may be denoted as: Û\hat{Σ}V^{T}, where Û denotes the first n columns of U and \hat{Σ} denotes the first n rows of Σ.

Therefore, after truncation, the economy SVD of A can be denotes as Â:=Û\hat{Σ}V^{T}.

### Private-Public Token Components

A tokenisation scheme can utilise the series sum expansion of an SVD-based token to allow for a distinction between different components of the token. For example, the different components could be characterised as public or private. By separating the components of a tokenised asset in this way, each component can be stored, processed, controlled and/or transferred separately.

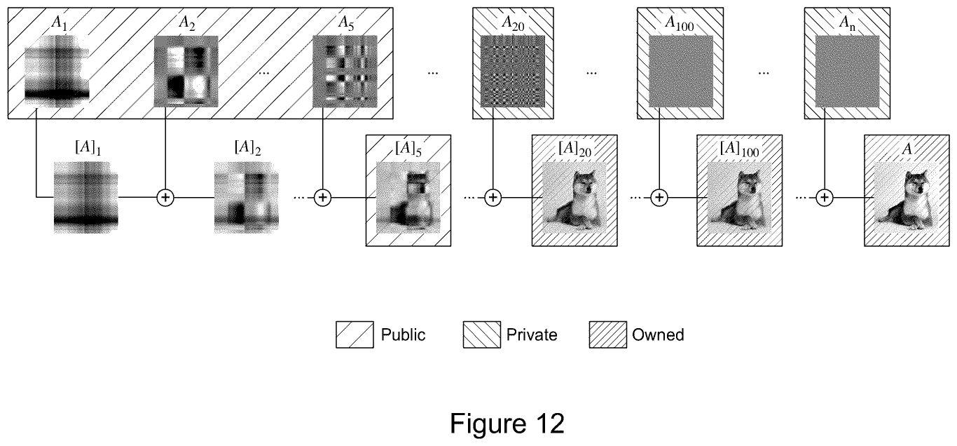

By way of example, consider a scenario in which a receiving party obtains a particular component of an NFT for a piece of artwork. This would, in effect, be akin to gaining control of a sub-NFT of the original artwork, as visualised in FIG. 12 which provides an illustration in which the series sum expansion of an SVD-based NFT is separated into public, private, and owned components.

For a suitable r, the first r components A₁, . . . , Aᵣ of the SVD expansion can be made publicly available, such that anybody can independently reconstruct the rank-r approximation, or thumbnail, [A]ᵣ from the available data, which are shown on the left side of FIG. 12.

Each of the remaining components can then be transferred privately and/or separately to different receiving parties by the controller e.g. original creator of the NFT image. When a receiver obtains the k-rank version of the NFT, the user (e.g. token controller) can either send them the set Aᵣ₊₁, Aᵣ₊₂, . . . , Aₖ or the pair [A]ₖ₋₁,Aₖ.

The separation of private and public (NFT) components allows for new token mechanics to be implemented. For instance, if the transfer of a component only reveals Aₖ privately to the receiver, then a particular receiver must collect all n components to be able to reconstruct the original image A. Public/private communication of the component(s) can be performed using any suitable known method e.g. via a public blockchain, or the internet; or for private communication via encrypted communication etc.

In other embodiments, token logic for a given token may be implemented to allow transfer of the components in sequence, revealing each component successively upon each transfer. This would allow anybody to construct the k-rank version of A, assuming k is the highest rank term that has been transferred. In this way, a token such as an NFT can ‘evolve’ over time, with each new transfer revealing new detail about the tokenised asset, e.g. an NFT image, until the original has been fully reconstructed.

It can be seen, therefore, that embodiments of the disclosure provide numerous technical benefits including, but not limited to, the provision of a more versatile approach to transfer and control of assets via a blockchain. Other benefits include improved data security for blockchain-based data transfers or processing in that unauthorised interception or access of one or more components may not be sufficient for the interceptor to reconstruct the asset in a meaningful way. For example, a partial copy of a sensitive document or file may be of no value to a hacker. Therefore, the hacker must somehow obtain all components to achieve their desired goal, even though each component may be transferred between the sending and receiving parties via entirely different means. This greatly reduces the likelihood of successful interception/access.

From one perspective, embodiments of the disclosure provide novel, improved and alternative approaches to “secret sharing” and new ways of implementing threshold schemes. Wikipedia describes these as follows (en.wikipedia.org/wiki/Secret_sharing):
“Secret sharing (also called ‘secret splitting’) refers to methods for distributing a secret among a group, in such a way that no individual holds any intelligible information about the secret, but when a sufficient number of individuals combine their ‘shares’, the secret may be reconstructed. Whereas ‘insecure’ secret sharing allows an attacker to gain more information with each share, ‘secure’ secret sharing is ‘all or nothing’ (where ‘all’ means the necessary number of shares).
In one type of secret sharing scheme there is one ‘dealer’ and ‘n players’. The dealer gives a share of the secret to the players, but only when specific conditions are fulfilled will the players be able to reconstruct the secret from their shares. The dealer accomplishes this by giving each player a share in such a way that any group of t (for threshold) or more players can together reconstruct the secret but no group of fewer than t players can. Such a system is called a (t, n)-threshold scheme (sometimes it is written as a (n, t)-threshold scheme).”

As seen above, embodiments of the disclosure allow for tokenised data to be stored on-chain in a secure, cryptographically enforced ledger, and distributed incrementally by various transfer methods to potentially different receivers. Machine executable logic can be implemented which automates and controls the distribution process, and includes criteria that must be met in order for a given component to be transferred to a particular recipient. If the criteria specified in the logic code is not met, the component(s) will not be release to the recipient(s).

This enables secure, automated solutions to be devised in which sensitive, private or otherwise valuable data can be distributed efficiently and only upon fulfilment of specified conditions. For example, one or more components may only be released to a specified receiver if the digital signatures of two-out-of-three pre-determined parties are provided, or if a specified amount of cryptocurrency has been transferred to a specified address, or a specified amount of time has elapsed or a particular date and time has been reached. There are, of course, numerous other possibilities beyond these examples.

### Minting:

In respect of embodiments which use the private-public components method described above, there is an assumption that each component Aₖ that a receiving party obtains is part of the exact original digital asset (e.g. image) A. This may require a degree of trust. In some embodiments, one or more attestations may be introduced to the minting (token generation) process when the token (e.g. NFT) is created. This enables verification of the authenticity and integrity of the component(s) that are received.

A simple example of such a minting process may comprise the following steps:
1. Generating an NFT/blockchain-based token A using an algorithm substantially as described in respect of algorithm 1, 2 or 3 above
2. Calculating the set of hashes [symbol] :=H(A), H(A₁), . . . H(Aₙ), H([A]₁), . . . , H([A]ₙ)
3. Generating a low-rank thumbnail [A]ᵣ
4. Minting (i.e. generating) token/NFT data D:=[A]ᵣ, [symbol] on-chain using a tokenisation protocol

This minting process includes an attestation [symbol] to the set of all NFT components Aᵢ and corresponding approximations [A]ᵢ. These attestations allow receiving parties to verify that each component they receive corresponds to a component of the original image matrix A. Note that [symbol] could be in many different formats, such as the root of a Merkle tree, or a hash chain where Hᵢ=H(Aᵢ∥Hᵢ₋₁) such that authenticity of each component can only be verified if the previous components have all been revealed.

In other embodiments, the generation step (step 1) can be omitted. In such cases, the SVD-based thumbnail technique may be used to advantage with a digital asset that has not been pre-processed using SVD. In other words, the set of hashes can be obtained using a data matrix derived from any digital asset, whether or not that is an SVD-based digital asset as generated according to algorithms 1, 2 or 3 herein.

### Scarcity

The perceived scarcity of a tokenised digital asset or asset collection is typically an important metric that helps to determine their value. In accordance with the disclosed SVD-based token design, there is a natural notion of scarcity since, for an m×n digital asset (e.g. image) matrix A, there are at most max(m,n) components, which is therefore the maximum number of components of a matrix that can be transferred and the maximum number of approximate versions of the digital asset that can be generated.

### Overview of Illustrative Embodiments of the Disclosure

Embodiments of the disclosure may described using any one or more of the alternative wordings:
a blockchain-based tokenisation method/protocol;
a method/protocol for using Singular Value Decomposition to obtain one or more digital assets and/or blockchain-based tokens;
a security method for generating, storing and/or transferring a blockchain-based token and/or digital asset.

The methods disclosed herein can be implemented using computer code, systems and/or computer equipment (apparatus, including hardware, software and/or firmware) that is arranged and/or operative to implement the methods.

Additionally, or alternatively, one or more preferred embodiments may provide methods and associated systems/code for:
obtaining at least one blockchain-based token that comprises, represents and/or is associated with at least one asset that has been processed using Singular Value Decomposition.

In accordance with an alternative form of wording, embodiments may provide methods and associated systems/code for:
obtaining an SVD-based asset; and
using the SVD-based asset to obtain and/or transfer a blockchain-based token.

Preferred embodiment(s) claimed, illustrated or described herein may comprise one or more of the following steps, which are provided by way of illustration only. In accordance with some embodiments, the order of the following steps may be altered relative to the order in which they are provided below; in some embodiments, one or more additional steps may be included that have not been listed below; in yet other embodiments one or more of the following steps may be omitted:
obtaining at least one digital asset;
the digital asset may be a digital/electronically formed representation of a virtual or physical asset; the digital asset may be generated by a user or received from one or more other parties; the digital asset may subsequently be use in the generation of a blockchain-based token such as, but not limited to, an NFT; in some cases, the digital asset may be or comprise a digital token that represents some other asset;
in some embodiments, this asset generation step may be omitted (see algorithm 3 in which and SVD is artificially constructed rather than being based on any initial digital asset(s))
generating the Singular Value decomposition of at least one digital asset; this may comprise
   obtaining a (data) matrix (A) for/of/representative of the digital asset;
   obtaining a set of (product) matrices from the matrix; for ease of reference, the set of matrices may be referred to herein as ‘the SVD of the digital asset’ or sometimes ‘the SVD of the token’, or sometimes simply ‘the SVD’;
   As noted above, in some embodiments the SVD may be artificially constructed from scratch rather than being dictated/influenced by or based on any existing digital assets (see algorithm 3, SVD-first approach).
processing the SVD in some way; in other words, regardless of how or from what the SVD is generated, it may then be processed at least in part;
   this processing may comprise one or more of:
      modifying one, some or all of the elements in at least one of the product matrices;
      the modification could comprise any type of modification operation and/or variable(s) suitable for a given use case; these could include, for example and without limitation:
         at least one random or pseudo-random parameter
         blockchain related data such as a block height or a hash of at least part of a block etc,
         data relating to or representative of one or more entities such as the current, original or intended owner of the asset/token; e.g. a cryptographic key, a password or identifier etc.
         data relating to a version or hierarchical attribute of the asset/token;
         a watermark or other embedded data suitable for verifying the authenticity and/or integrity of the digital asset;
         encrypting one, some or all of the elements in the product matrices or the data matrix that is generated after the SVD has been modified;
         truncating, cropping or reducing at least one of the matrices;
multiplying out the (modified) product matrices to obtain a new data matrix A′ that has been obtained using Singular Value Decomposition; the modified matrix is, therefore, based upon the original data matrix A of the digital asset but has been processed using SVD; for ease of reference, we may refer to this new matrix as the “SVD-based digital asset/token”;
the modified matrix A′ may be processed in any suitable way to provide the digital asset in a desired format e.g. so that it is suitable for viewing, listening to or watching via a software application;
associating the SVD-based digital asset with a blockchain-based token; this may comprise generating a new token that comprises (represents or is otherwise associated with) the SVD-based digital asset; in other cases, this may comprise alteration or replacement of the asset that an existing blockchain-based token represents;
sending, from a sender to at least one recipient, one or more of: the modified matrix A′, an encrypted version of the modified matrix A′, the processed version of the modified matrix;
writing the SVD-based digital asset and/or the token to the blockchain. In some embodiments, the SVD-based asset is stored on-chain while in others it may be stored off-chain.

In some cases, a single party/user/actor or single group of parties/users/actors may perform all of the steps of a method disclosed or claimed herein. In other cases, one or some of the steps may be performed by at least one further user/group/party/actor.

### Enumerated Clauses

The following enumerated clauses are provided as non-limiting examples of some illustrative embodiments of the disclosure. Features recited in respect of one set of clauses can be incorporated into one or more other sets of clauses.

### Clause Set 1:

The embodiments defined in clause set 1 may relate in particular to the section entitled “Image-first approach” and, in particular, algorithms 1 and 2 as disclosed herein.

Clause 1.1: A computer-implemented method comprising the step:
using Singular Value Decomposition (SVD) to generate at least one SVD-based digital asset (SVD-DA). Additionally, or alternatively, it may comprise the step of using SVD to generate at least one blockchain-based token associated with the SVD-based digital asset (SVD-DA).

The method may be a method of obtaining e.g. generating a digital asset, a blockchain-based asset (e.g. token) or both. Additionally, or alternatively, it may be described as: a (blockchain-based) tokenisation method, a method for secure generation, transfer and/or transfer of blockchain-based tokens and/or digital assets.

Additionally, or alternatively, the method may be described as a computer-implemented method for using Singular Value Decomposition (SVD) to generate a blockchain-based asset that is derived from or associated with a SVD-based digital asset (SVD-DA).

Additionally, or alternatively, the method may be described as a computer-implemented method comprising the step of generating, obtaining, storing, transferring or otherwise processing a blockchain-based asset that is derived from or associated with at least one SVD-based digital asset (SVD-DA).

The method may be implemented in machine executable code, and arranged for execution by one or more processors. The machine-executable code may be stored in memory associated with the one or more processors.

Clause 1.2. A method according to clause 1.1, wherein the method comprises
obtaining the SVD of an initial digital asset (DA) or a plurality of initial digital assets (DAs). The initial DA may be referred to as a base or underlying asset. For readability and ease of reference, we may refer to an initial digital asset in the singular. However, the term is intended to include and be interpreted as covering a plurality of initial digital assets.

Clause 1.3. A method according to clause 1.2, wherein the SVD is obtained of the initial digital asset (DA) and the method further comprises one or more of:
i) obtaining the SVD matrices of the initial digital asset (DA);
ii) modifying at least one matrix of the SVD matrices to produce a modified version of the SVD matrices;
ii) generating the SVD-based digital asset (SVD-DA) from the modified version of the SVD matrices.

Clause 1.4. A method according to clause 1.2 or clause 1.3, and further comprising one or more of:
i) representing the initial digital asset (DA) as a matrix A;
ii) using the matrix A to obtain the SVD matrices of the initial digital asset (DA):

U,Σ,V^{T}←SVD(A);
iii) modifying at least one matrix of the obtained SVD matrices to provide a modified version of the SVD matrices:

U′,Σ′,V^{T}′←M(U,Σ,V^{T});
iv) multiplying the modified version of the SVD matrices to provide the SVD-based digital asset (SVD-DA):

A′←U′Σ′V^{T}′.

Clause 1.5. A method according to any of clause 1.3 or 1.4, wherein modifying the at least one matrix of the SVD matrices comprises:
i) using a random or pseudo random modification operation; and/or
ii) a substitution operation.

Clause 1.6. A method according to clause 1.2, wherein the SVD is obtained of the plurality of initial digital assets (DAs) and the method further comprises one or more of:
i) choosing or otherwise obtaining the SVD matrices of the plurality of initial digital assets;
ii) choosing or otherwise obtaining a column vector;
iii) generating the SVD-based digital asset (SVD-DA) from a new column vector based on the selected column vector.

The column vector V_{⊥}^{T} may be a newly chosen/obtained selection of values, represented as a column vector.

Clause 1.7. A method according to clause 1.2 or clause 1.6, and further comprising one or more of:
i) representing the plurality of initial digital assets (DAs) as a matrix A that comprises a plurality of column vectors, each column vector representing an initial digital asset in the plurality of initial digital assets (DAs);
ii) using matrix A to obtain the SVD matrices of the plurality of initial digital assets (DAs):

U,Σ,V^{T}←SVD(A);
iii) choosing or otherwise obtaining a column vector;

$${V}_{⊥}^{T}$$

iv) generating a new column vector:

$${A}_{⊥} ← U \sum {V}_{⊥}^{T}$$

v) generating a new column vector which comprises a linear combination of the column vectors;
vi) reshaping the new column vector A_{⊥} to generate the SVD-based digital asset:

A′←R(A_{⊥})

Clause 1.8. A method according to clause 1.6 or 1.7, wherein the method further comprises:
modifying at least one matrix of the SVD matrices;
preferably wherein the modifying step comprises:
   i) using a random or pseudo random modification operation; and/or
   ii) a substitution operation.

Clause 1.9. A method according to any preceding clause in this clause set, wherein the method further comprises:
generating a set of SVD-based digital assets (SVD-DAs) based on the initial digital asset (DA) or the plurality of initial digital assets (DAs).

Clause 1.10. A method according to clause 1.9, wherein:
i) the set of SVD-based digital assets is generated based on the initial digital asset (DA) and the method further comprises:
   repeating, at least once, the step of modifying at least one matrix of the SVD matrices to produce a modified version of the SVD matrices;
or
ii) the set of SVD-based digital assets (SVD-DAs) is generated based on the plurality of initial digital assets (DAs) and the method further comprises:
   repeating, at least once, the step of choosing or otherwise obtaining a column vector.

Clause 1.11. A method according to any preceding clause in this clause set, wherein the blockchain-based token:
i) comprises token ID and/or metadata associated with a tokenised asset; and/or
ii) is associated with or represents one or more of: a physical, virtual or digital tokenised asset;
   preferably wherein the tokenised asset is or comprises an aesthetic work; computer code such as source code or executable code; data relating to one or more individual persons; and/or
iii) is minted and/or controlled by a portion of machine executable code, e.g. smart contract; and/or
iv) is a non-fungible token (NFT).

Clause 1.12. A method of generating a blockchain-based non-fungible token (NFT), the method comprising the steps of:
using Singular Value Decomposition (SVD) to generate at least one SVD-based digital asset (SVD-DA); and
associating the at least one SVD-based digital asset (SVD-DA) with one or more of: logic code for influencing the creation or use of the NFT;
   an identifier for uniquely identifying the NFT and/or at least one SVD-based digital asset (SVD-DA);
   metadata related to the NFT and/or at least one SVD-based digital asset (SVD-DA);

The method may further comprise: generating the at least one SVD-based digital asset (SVD-DA) comprises obtaining the SVD of one or more initial digital assets. The logic code, identifier, metadata and/or at least one SVD-based digital asset (SVD-DA) are stored in at least one transaction on a blockchain; Additionally, or alternatively, the logic code comprises machine-executable code that, when executed, tests at least one condition and performs at least one condition-based action if the condition is satisfied.

Clause 1.13. Computer equipment comprising:
memory comprising one or more memory units; and
processing apparatus comprising one or more processing units, wherein the memory stores code arranged to run on the processing apparatus, the code being configured so as when on the processing apparatus to perform the method of any of clauses 1.1 to 1.12.

Clause 1.14. A computer implemented system arranged to implement the method of any of clauses 1.1 to 1.12, and further comprising any one or more of:
computer equipment as defined in clause 1.13;
a digital wallet;
an exchange platform; this may be a currency exchange platform and/or a cryptocurrency exchange platform;
a node on a blockchain network.

Clause 1.15. A computer program embodied on computer-readable storage and configured so as, when run on one or more processors, to perform the method of any of clause 1.1 to 1.13;
and optionally wherein:
   the computer program comprises logic code or a smart contract associated with a token, optionally wherein the token is a non-fungible token (NFT);
   the computer-readable storage is provided by or in association with a node on a blockchain network.

### Clause Set 2:

The embodiments defined in clause set 2 may relate in particular to the section entitled “SVD-first approach” and, in particular, algorithm 3 as disclosed herein.

Clause 2.1. A computer-implemented method comprising:
using a user-specified Singular Value Decomposition (SVD) to generate at least one blockchain-based token or SVD-based digital asset (SVD-DA).

Clause 2.2. A method according to clause 2.1, and comprising one or more of:
i) obtaining a data matrix (A) from the user-specified SVD;
ii) using the at least one SVD-based digital asset (SVD-DA) to generate the at least one blockchain-based token.

Clause 2.3. A method according to clause 2.1 or clause 2.2, wherein the user specified SVD:
i) is obtained from, constructed by and/or specified by a plurality of SVD product matrices: U, Σ, V^{T}
ii) is obtained using one or more basis feature(s) that are chosen, specified by or otherwise obtained from at least one user.

Clause 2.4. A method according to clause 2.1 or clause 2.2, wherein the method further comprises one or more of:
generating a feature matrix U, wherein one some or all of the elements in the feature matrix are obtained from at least one user;
generating a plurality of basis feature matrices, wherein each matrix in the plurality of basis feature matrices:
   comprises at least one element obtained by a user; and/or
   defines or represents a basis feature obtained from at least one user and/or
   defines or represents a basis feature for the at least one SVD-based digital asset.

Clause 2.5. A method according to clause 2.4 and further comprising one or more of:
reshaping each feature matrix in the plurality of basis feature matrices into a column vector;
generating a feature matrix U from the plurality of basis feature matrices, preferably wherein each basis feature matrix in the plurality of basis feature matrices has been reshaped.

Clause 2.6. A method according to any of clause 2.2 to 2.5, and further comprising one or more of:
i) choosing a set k of singular values (σ₁, . . . , σₖ);
   preferably wherein k is the number of basis feature matrices in the plurality of basis feature matrices;
ii) obtaining a k×k diagonal matrix (Σ) having the set of singular values (σ₁, . . . , σₖ) on its diagonal;
iii) obtaining a set of N k×1 column vectors, preferably wherein:
   N is obtained by a user and/or defines the number of SVD-based digital assets that are to be generated;
iv) obtaining a k×N matrix (V^{T}) that uses the set of column vectors as its columns
v) using the feature matrix U, diagonal matrix (Σ) and set of column vectors (V^{T}) to obtain a data matrix (A)

Clause 2.7. A method according to any preceding clause in clause set 2, wherein:
obtaining the data matrix (A) comprises multiplying the SVD product matrices, wherein the SVD product matrices comprise the feature matrix U, the diagonal matrix (Σ) and the k×N matrix (V^{T}): A←UΣV^{T}

Clause 2.8. A method according to any preceding clause in clause set 2, and comprising one or more of:
reshaping at least one column of the data matrix;
using at least one column of the data matrix to generate the SVD-based digital asset.

Clause 2.9. A method according to any preceding clause in clause set 2, wherein:
the at least one blockchain-based token is a non-fungible token (NFT).

Clause 2.10. A method according to any preceding claim, wherein:
the user specified SVD is generated using input or basis features obtained from a plurality of users.

Clause 2.11. A method according to any preceding clause in clause set 2, and comprising the step of:
processing at least one element in the data matrix and/or at least one matrix in the plurality SVD product matrices; wherein processing comprises modification, approximation, truncation, encryption and/or substitution of the at least one element.

Clause 2.12. Computer equipment comprising:
memory comprising one or more memory units; and
processing apparatus comprising one or more processing units, wherein the memory stores code arranged to run on the processing apparatus, the code being configured so as when on the processing apparatus to perform the method of any of clauses 2.1 to 2.11.

Clause 2.13. A computer implemented system arranged to implement the method of any of clauses 2.1 to 2.11, and further comprising any one or more of:
computer equipment as defined in clause 2.12;
a digital wallet; an exchange platform (e.g. a currency and/or cryptocurrency exchange platform); a node on a blockchain network.

Clause 2.14. A computer program embodied on computer-readable storage and configured so as, when run on one or more processors, to perform the method of any of clauses 2.1 to 2.11.

Clause 2.15. A computer program according to clause 2.14, wherein:
the computer program comprises logic code or a smart contract associated with a blockchain-based token;
optionally wherein:
the blockchain-based token is a non-fungible token (NFT); and/or
the computer-readable storage is provided by or in association with a node on a blockchain network.

### Clause Set 3:

The embodiments defined in clause set 3 may relate in particular to the sections entitled “thumbnails”, “Private-Public Token Components” and “minting” as disclosed herein.

Clause 3.1. A computer-implemented method, comprising:
i) generating a m×n data matrix (A) for a digital asset (DA);
ii) obtaining the Singular Value Decomposition (SVD) of the matrix (A) to provide a plurality of matrices;
iii) processing one or more of the matrices in the plurality of matrices to provide an approximation of the digital asset (DA);
iv) associating the approximation of the digital asset (DA) with a blockchain-based token.

Clause 3.2. A method according to clause 3.1, wherein:
i) the step of processing the one or more matrices to provide an approximation of the digital asset comprises truncating the one or more matrices; and/or
ii) the approximation of the digital asset (DA) is a low rank approximation [A]ᵣ of the matrix A.

Clause 3.3. A method according to clause 3.2 or clause 3.1, wherein:
i) the method further comprises: storing the blockchain-based token on a blockchain ledger (150), and storing the approximation of the digital asset in the blockchain or in at least one off-blockchain storage resource; and/or
ii) the blockchain-based token is a non-fungible token (NFT).

Clause 3.4. A computer-implemented method, comprising:
obtaining a plurality of components, wherein each component in the plurality comprises or derives from a matrix that is a term in the series expansion of a data matrix; and
associating at least one component, or a derivative thereof, with a blockchain-based token.

Clause 3.5. A method according to clause 3.4, and comprising the step of:
obtaining the data matrix by multiplying the product matrices of a Singular Value Decomposition (SVD);

Clause 3.6. A method according to clause 3.4 or clause 3.5, wherein the data matrix:
i) derives from one or more digital assets; or
ii) comprises one or more elements that are selected or otherwise provided by a user.

Clause 3.7. A method according to any of clauses 3.4 to clause 3.6, and further comprising the step of:
processing at least one element of:
   the data matrix or
   at least one element of at least one of the product matrices of the SVD;
preferably wherein processing comprises one or more of:
modification, substitution, removal, encryption.

Clause 3.8. A method according to any of clauses 3.4 to clause 3.7, the method further comprising the step:
making at least one of the plurality of components available, publicly or privately, to one or more recipients.

Clause 3.9. A method according to any of clauses 3.4 to clause 3.8 and comprising the step of:
using or providing machine executable code to generate or control the use of the blockchain-based token.

Clause 3.10. A computer-implemented method, comprising:
i) obtaining a hash of at least one component in a plurality of components, wherein each component in the plurality comprises or derives from a matrix that is a term in the series expansion of an initial matrix that is derived from or represents a digital asset;
ii) using Singular Value Decomposition (SVD) to obtain an approximation of the digital asset;
iii) generating token data for a digital token, the token data comprising the approximation of the digital asset and/or the hash.

Clause 3.11. A method according to clause 3.10, wherein the step of obtaining the approximation comprises
i) processing one or more product matrices obtained from the SVD of the initial matrix; and/or
ii) truncating one or more matrices, preferably wherein the one or more matrices are obtained from the SVD of the initial matrix.

Clause 3.12. A method according to clause 3.10 or clause 3.11, wherein:
i) the approximation of the digital asset (DA) is a low rank approximation of the digital asset; and/or
ii) the hash is provided in the token data as the root of a Merkle tree or a hash chain

Clause 3.13. Computer equipment comprising:
memory comprising one or more memory units; and
processing apparatus comprising one or more processing units, wherein the memory stores code arranged to run on the processing apparatus, the code being configured so as when on the processing apparatus to perform the method of any of clauses 3.1 to 3.12.

Clause 3.14. A computer implemented system arranged to implement the method of any of clauses 3.1 to clause 3.12, and further comprising any one or more of:
computer equipment as defined in clause 3.13;
a digital wallet;
an exchange platform; this may be a currency exchange platform and/or a cryptocurrency exchange platform;
a node on a blockchain network;
computer-executable code arranged to generate and/or control the use of a blockchain-based token.

Clause 3.15. A computer program embodied on computer-readable storage and configured so as, when run on one or more processors, to perform the method of any of clauses 3.1 to clause 3.12,
preferably wherein:
   i) the computer program comprises logic code or a smart contract associated with a token, optionally wherein the token is a non-fungible token (NFT); and/or
   ii) the computer-readable storage is provided by or in association with a node on a blockchain network.

### Clause Set 4:

The embodiments defined in clause set 4 may relate in particular to the section entitled “SVD matrix encryption” as disclosed herein.

Clause 4.1. A computer implemented method comprising the steps:
obtaining the Singular Value Decomposition (SVD) of:
   a digital asset (DA); or
   a blockchain-based token that is associated with a/the digital asset;
modifying the SVD to obtain a modified Singular Value Decomposition (M-SVD);
using the modified SVD (M-SVD) to obtain a new blockchain-based token.

Clause 4.2. A method according to clause 4.1, wherein:
i) the SVD comprises a plurality of product matrices;
ii) the step of obtaining the SVD provides a plurality of matrices; and/or
ii) the modified SVD comprises a plurality of matrices, wherein at least one element of at least one of the plurality of matrices is altered from its previous state as a result of the modification.

Clause 4.3. A method according to clause 4.1 or clause 4.2, wherein the step of using the modified SVD to obtain a new blockchain-based token comprises using the modified SVD to obtain:
i) a matrix that represents a modified version of the digital asset or blockchain-based token; and/or
ii) a SVD-based digital asset (SVD-DA).

Clause 4.4. A method according to any preceding clause in clause set 4, wherein:
i) the SVD of the digital asset (DA) or blockchain-based token is obtained from a matrix for the digital asset; and/or
ii) the method comprises the step of obtaining a data matrix for the digital asset (DA);
iii) modifying the SVD comprises:
   modifying at least one element of at least one matrix; and/or
   modifying at least one matrix of the plurality of matrices.

Clause 4.5. A method according to any preceding clause in clause set 4, wherein modifying the SVD comprises performing a modification that uses or is based on one or more of: obtained data;
at least one parameter that is chosen, calculated or otherwise obtained by an owner of the digital asset or blockchain-based token;
at least one parameter that is related to, dependent on, secret to, unique to, or representative of at least one organisation, individual or other entity;
a blockchain-related parameter such as the height of at least one block, a time stamp derived from a block, a transaction ID or a hash of a block or part thereof;
at least one cryptographic key or digital signature, or data derived therefrom.

Clause 4.6. A method according to any preceding clause in clause set 4, the method further comprising:
encrypting at least part of a matrix obtained from the modified SVD (M-SVD) to provide an encrypted matrix; and
sending the encrypted matrix from a sender to at least one recipient.

Clause 4.7. A method according to clause 4.6, wherein the matrix is encrypted using one or more of:
i) a shared secret generated between the sender and the at least one recipient;
ii) a cryptographic key;
iii) a cipher, such as a stream cipher or a block cipher.

Clause 4.8. A computer implemented method comprising the steps:
obtaining a matrix for a digital asset or a blockchain-based token that is associated with a based digital asset;
encrypting one, some or all elements of the matrix to provide an encrypted matrix.

Clause 4.9. A method according to clause 4.8, wherein:
i) the digital asset and/or blockchain-based token has been obtained using Singular Value Decomposition (SVD); and/or
ii) the matrix is obtained from a plurality of matrices that have been generated using a Singular Value Decomposition (SVD) operation.

Clause 4.10. A method according to clause 4.8 or clause 4.9, wherein the matrix is encrypted using one or more of:
i) a shared secret generated between the sender and the at least one recipient;
ii) a cryptographic key, optionally obtained using a Diffie-Hellman process;
iii) a cipher, such as a stream cipher or a block cipher.

Clause 4.11. A method according to any of clauses 4.8 to 4.10, and further comprising one or more of:
i) using a cryptographic key as a seed to a provide random modification to one or more elements of at least one matrix;
ii) sending the encrypted matrix to at least one recipient;
iii) decrypting the encrypted matrix, preferably wherein the decryption is performed:
   by at least one recipient of the blockchain-based token and/or digital asset; and/or
   using a shared secret.

Clause 4.12. Computer equipment comprising:
memory comprising one or more memory units; and
processing apparatus comprising one or more processing units, wherein the memory stores code arranged to run on the processing apparatus, the code being configured so as when on the processing apparatus to perform the method of any of clauses 4.1 to 4.11.

Clause 4.13. A computer implemented system arranged to implement the method of any of clauses 4.1 to 4.11, and further comprising any one or more of:
computer equipment as defined in clause 4.12;
a digital wallet;
an exchange platform; this may a currency exchange platform and/or a cryptocurrency exchange platform
a node on a blockchain network;
computer-executable code arranged to generate and/or control the use of a blockchain-based token.

Clause 4.14. A computer program embodied on computer-readable storage and configured so as, when run on one or more processors, to perform the method of any of clauses 4.1 to 4.11.

Clause 4.15. A computer program according to clause 4.14, wherein:
the computer program comprises logic code or a smart contract associated with a token, optionally wherein the token is a non-fungible token (NFT);
the computer-readable storage is provided by or in association with a node on a blockchain network.

### Example System Overview

Embodiments of the present disclosure may be implemented in conjunction with a blockchain. Without limitation, this section provides technical details of system(s) which can be used to implement various embodiments of the disclosure.

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 (often referred to as “miners”) that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout.

A blockchain node 104 may be configured to forward transactions 152 to other blockchain nodes 104, and thereby cause transactions 152 to be propagated throughout the network 106. A blockchain node 104 may be configured to create blocks 151 and to store a respective copy of the same blockchain 150 in their respective memory. A blockchain node 104 may also maintain an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Any given blockchain node may be configured to perform one or more of the following operations: validating transactions, storing transactions, propagating transactions to other peers, performing consensus (e.g. proof-of-work)/mining operations. In some examples, each type of operation is performed by a different node 104. That is, nodes may specialise in particular operation. For example, a nodes 104 may focus on transaction validation and propagation, or on block mining. In some examples, a blockchain node 104 may perform more than one of these operations in parallel. Any reference to a blockchain node 104 may refer to an entity that is configured to perform at least one of these operations.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position” or “nonce”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

Some account-based transaction models share several similarities with the output-based transaction model described herein. For example, as mentioned above, the data field of an account-based transaction may point back to a previous transaction, which is equivalent to the input of an output-based transaction which references an outpoint a previous transaction. Thus both models enable linking between transactions. As another example, an account-based transaction contains a “recipient” field (in which a receiving address of an account is specified) and a “value” field (in which an amount of digital asset may be specified). Together the recipient and value fields are equivalent to the output of an output-based transaction which may be used to assign an amount of digital asset to a blockchain address. Similarly, an account-based transaction has a “signature” field which includes a signature for the transaction. The signature is generated using the sender's private key and confirms the sender has authorized this transaction. This is equivalent to an input/unlocking script of an output-based transaction which, typically, includes a signature for the transaction. When both types of transaction are submitted to their respective blockchain networks, the signatures are checked to determine whether the transaction is valid and can be recorded on the blockchain. On an account-based blockchain, a “smart contact” refers to a transaction that contains a script configured to perform one or more actions (e.g. send or “release” a digital asset to a recipient address) in response to one or more inputs (provided by a transaction) meeting one or more conditions defined by the smart contact's script. The smart contract exists as a transaction on the blockchain, and can be called (or triggered) by subsequent transactions. Thus, in some examples, a smart contract may be considered equivalent to a locking script of an output-based transaction, which can be triggered by a subsequent transaction, and checks whether one or more conditions defined by the locking script are met by the input of the subsequent transaction.

### 3. UTXO-BASED MODEL

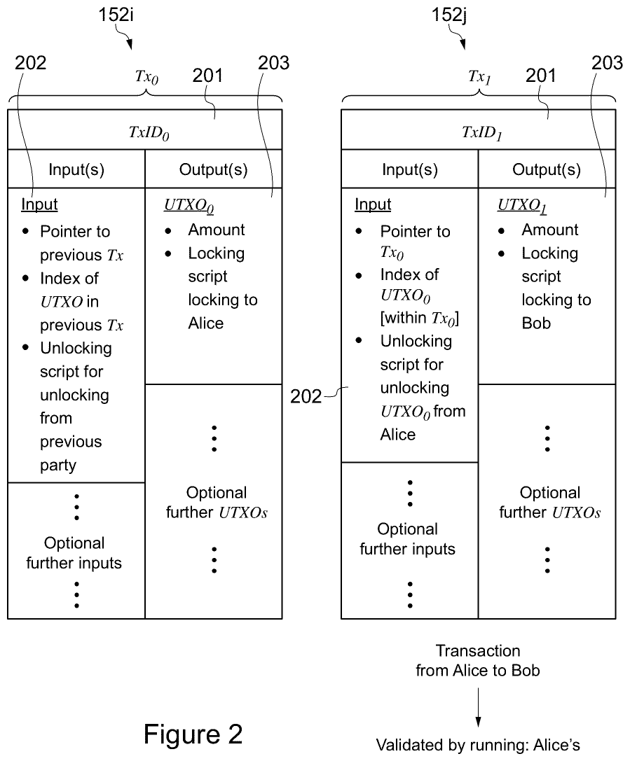

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger.

The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig PA] which requires a signature Sig PA of Alice in order for UTXO₀ to be redeemed (strictly, in order for a subsequent transaction attempting to redeem UTXO₀ to be valid). [Checksig PA] contains a representation (i.e. a hash) of the public key PA from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig PA> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria).

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key PA. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 4. SIDE CHANNEL

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 5. CLIENT SOFTWARE

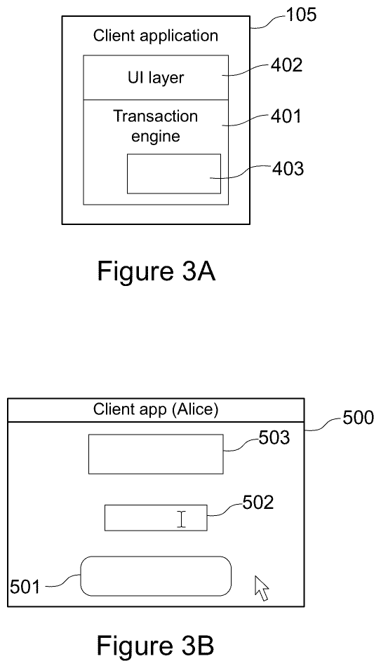

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively, or additionally, the UI elements may comprise one or more data entry fields 502, through which the user can . . . . These data entry fields are rendered via the user output means, e.g. on-screen, and the data can be entered into the fields through the user input means, e.g. a keyboard or touchscreen. Alternatively, the data could be received orally for example based on speech recognition.

Alternatively, or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### 6. NODE SOFTWARE

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains one or more of: a consensus module 455C (for example, proof-of-work), a propagation module 455P and a storage module 455S (for example, a database). The consensus module 455C may contain a validation module (not shown) configured to validate transactions according to the blockchain protocol. The validation module may instead be separate from the consensus module 455C. One or more of the modules may operate in parallel. A node 104 may contain additional modules. The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txⱼ based on the pointer in the input of Txⱼ. Txⱼ may be published on the blockchain 150, in which case the protocol engine may retrieve Txⱼ from a copy of a block 151 of the blockchain 150 stored at the node 104. Alternatively, Txⱼ may yet to have been published on the blockchain 150. In that case, the protocol engine 451 may retrieve Txⱼ from the ordered set 154 of unpublished transactions maintained by the node 104. Either way, the script engine 451 identifies the locking script in the referenced output of Txⱼ and passes this to the script engine 452.

The script engine 452 thus has the locking script of Txⱼ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### 7. FURTHER REMARKS

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only.

More generally there may be provided a method, apparatus or program in accordance with any one or more of the following Statements.

### TERMINOLOGY

Without limitation, the following terms may be used herein as provided below:
“processing” includes, but is not limited to, one or more of: generating, storing, transmitting (over an electronic network), transferring control of, accessing, viewing, or modifying;
‘obtaining’ comprises any method of coming into possession of some entity, and includes generating, calculating, selecting, or receiving from one or more sources;
“asset”, “resource” and “item” may be used interchangeably, and are intended to include physical, virtual or digital assets/resources/items;
“digital asset” may mean any asset which has been or is capable of being processed or stored on an electronic processing device, and may comprise a portion of digital content/data. In some cases, a digital asset may be or comprise a digital representation of a physical or virtual asset e.g. a scan, photograph, recording or other electronic version of a physical or virtual asset; the content, purpose or format of the digital asset is not limited; for example, a digital asset may comprise digital content such as, but not limited to, images, sound, video, computer code etc.
‘SVD-based digital asset’ may mean a digital asset that has been obtained using the Singular Value Decomposition (SVD) in accordance with any embodiment of the disclosure;
‘user’ may mean one or a group of humans, or one or a group of computer-based resources; by way of example, the at least one human may be a token creator or administrator, a creator or controller of an asset, which may or may not be a digital asset, such as an artist or designer or manufacturer etc; the at least one computer-based resource may, in some examples, comprise processor-based hardware and at least one portion of executable code which is operative when executed on the hardware to perform one or more of the method steps disclosed and/or claimed herein;
‘derived from’ and ‘based on’ may be used interchangeably;
‘blockchain-based asset/token’ may be used to refer to a digital asset/token that is, or is capable of being, stored in a blockchain ledger; the token may be a fungible or non-fungible token (NFT) and may be formed in accordance with any suitable, known tokenisation protocol; in some cases, the blockchain-based asset/token may comprise an identifier for uniquely identifying the underlying (base) asset that the token represents, and/or metadata; the blockchain-based asset/token may comprise or be associated with logic code relating to the generation or use of the asset/token e.g. a smart contract; the term ‘SVD-based blockchain asset/token’ may be used interchangeably herein with ‘blockchain-based asset/token’.
‘transfer’ may mean transfer of an entity such as a digital, physical or virtual asset, or may mean transfer of control/ownership of that entity;
‘component’ may comprise an element of an entity; the term may be used interchangeably with ‘portion’, ‘part’, ‘element’ or ‘sub-component’;
“control” and “ownership” may be used interchangeably herein for convenience although it is to be noted that they are not necessarily synonymous. For example, an entity (individual, organisation, nominated group etc.) may have control over an asset on behalf of an owner, and may be authorised for such control by the owner. In some cases, the term ‘owner/ownership’ may denote a control hierarchy wherein the highest level of control belongs to the owner and (potentially temporary) authorisation/control is delegated to or shared with a controlling third party;
“Bitcoin” as used herein is intended to include all protocols and implementations that derive or deviate from the original protocol set out by Satoshi Nakamoto in the Bitcoin whitepaper ‘Bitcoin: a peer-to-peer electronic cash system’ [2008]. The Bitcoin blockchain may be referred to herein for the sake of convenience as it is the most widely known. However, embodiments of the disclosure are not limited in this regard and other blockchain protocols and implementations fall within the scope of the present disclosure, whether they derive from the original Bitcoin protocol or not;
Herein, any uses of, or reference to, the term “cryptocurrency” may be replaced with and/or used interchangeably with “token”, “asset” or “protocol-specific transfer item”. The term “Bitcoin” may be replaced with and/or used interchangeably with “blockchain protocol” or “one or more examples of a blockchain protocol”.

1. A computer-implemented method comprising the step:
generating, storing or transferring a blockchain-based asset that is derived from or associated with at least one Singular Value Decomposition (SVD)-based digital asset (SVD-DA) that is obtained using the SVD of an initial digital asset (DA) or a plurality of initial digital assets (DAs).

2. The method of claim 1, wherein the method further comprises one or more of:
i) obtaining SVD matrices of the initial digital asset (DA) or initial digital assets (DAs);
ii) modifying at least one matrix of the SVD matrices to produce a modified version of the SVD matrices;
ii) generating the SVD-based digital asset (SVD-DA) from the modified version of the SVD matrices.

3. The method of claim 1, and further comprising one or more of:
i) representing the initial digital asset (DA) as a matrix (A);
ii) using the matrix (A) to obtain SVD matrices of the initial digital asset (DA)
iii) modifying at least one matrix of the obtained SVD matrices to provide a modified version of the SVD matrices;
iv) multiplying the modified version of the SVD matrices to provide the SVD-based digital asset (SVD-DA).

4. The method of claim 2, wherein modifying the at least one matrix of the SVD matrices comprises:
i) using a random or pseudo random modification operation; and/or
ii) a substitution operation.

5. The method of claim 1, wherein the SVD is obtained from the plurality of initial digital assets (DAs) and the method further comprises one or more of:
i) choosing or otherwise obtaining SVD matrices of the plurality of initial digital assets;
ii) choosing or otherwise obtaining a column vector;
iii) generating the SVD-based digital asset (SVD-DA) from a new column vector based on the selected column vector.

6. The method of claim 1, and further comprising one or more of:
i) representing the plurality of initial digital assets (DAs) as a matrix (A) that comprises a plurality of column vectors, each column vector representing an initial digital asset in the plurality of initial digital assets (DAs);
ii) using the matrix (A) to obtain SVD matrices of the plurality of initial digital assets (DAs);
iii) choosing or otherwise obtaining a column vector;
iv) generating a new column vector;
v) reshaping the column vector to generate the SVD-based digital asset.

7. The method of claim 5, wherein the method further comprises:
modifying at least one matrix of the SVD matrices.

8. The method of claim 1, wherein the method further comprises:
generating a set of SVD-based digital assets (SVD-DAs) based on the initial digital asset (DA) or the plurality of initial digital assets (DAs).

9. The method of claim 8, wherein:
i) the set of SVD-based digital assets is generated based on the initial digital asset (DA) and the method further comprises:
repeating, at least once, the step of modifying at least one matrix of the SVD matrices to produce a modified version of the SVD matrices;
or
ii) the set of SVD-based digital assets (SVD-DAs) is generated based on the plurality of initial digital assets (DAs) and the method further comprises:
repeating, at least once, the step of choosing or otherwise obtaining a column vector.

10. The method of A claim 1, wherein the blockchain-based asset:
i) comprises token ID and/or metadata associated with a tokenised asset; and/or
ii) is associated with or represents one or more of: a physical, virtual or digital tokenised asset; and/or
iii) is minted and/or controlled by a portion of machine executable code; and/or
iv) is a non-fungible token (NFT).

11-13. (canceled)

14. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a computer-implemented method comprising the step:
generating, storing or transferring a blockchain-based asset that is derived from or associated with at least one Singular Value Decomposition (SVD)-based digital asset (SVD-DA) that is obtained using the SVD of an initial digital asset (DA) or a plurality of initial digital assets (DAs).

15. (canceled)

16. A computer program product embodied on non-transitory computer-readable storage media and configured so as, when run on one or more processors, the one or more processor perform a computer-implemented method comprising the step:
generating, storing or transferring a blockchain-based asset that is derived from or associated with at least one Singular Value Decomposition (SVD)-based digital asset (SVD-DA) that is obtained using the SVD of an initial digital asset (DA) or a plurality of initial digital assets (DAs)
the non-transitory computer-readable storage media being provided by or in association with a node on a blockchain network.

17. The computer program product of claim 16, wherein the computer program product comprises logic code or a smart contract associated with a token, optionally wherein the token is a non-fungible token (NFT); and
the computer-readable storage is provided by or in association with a node on a blockchain network.

18. The method of claim 6, wherein generating the new column vector comprises generating a linear combination of vectors.

19. The method of claim 7, wherein modifying the at least one matrix of the SVD matrices comprises:
i) using a random or pseudo random modification operation; and/or
ii) using a substitution operation.

20. The method of claim 10, wherein the tokenised asset is or comprises an aesthetic work; computer code such as source code or executable code; data relating to one or more individual persons.
